(19) United States
(12) Patent Application Publication
(10) Pub. No.: US 2026/0209517 A1
(43) Pub. Date: Jul. 23, 2026

(54) THERMALLY-CONDUCTIVE SILICONE COMPOSITION, THERMALLY-CONDUCTIVE MEMBER, AND HEAT DISSIPATION STRUCTURE

(71) Applicants: DOW SILICONES CORPORATION, Midland, MI (US); DOW TORAY CO., LTD., Shinagawa-Ku, Tokyo (JP)

(72) Inventors: Kenji OTA, Ichihara-shi, Chiba (JP); Shin YOSHIDA, Ichihara-Shi, Chiba (JP); Eric JOFFRE, Midland, MI (US); Nanguo LIU, Midland, MI (US)

(21) Appl. No.: 19/142,195

(22) PCT Filed: Dec. 21, 2023
(86) PCT No.: PCT/US2023/085518

§ 371 Date: Jun. 21, 2025

Related U.S. Application Data
(60) Provisional application No. 63/435,019, filed on Dec. 23, 2022.

(51) Int. Cl. C08L 83/04; C08K 3/04; C08K 3/22; H01M 10/653

(52) U.S. Cl. CPC C08L 83/04; C08K 3/04; C08K 3/22; H01M 10/653; C08K 2003/2227; C08K 2201/001; C08K 2201/003; C08L 2205/02; C08L 2205/03

(57) ABSTRACT

A thermally conductive silicone composition comprises (A) 100 parts by mass of an alkenyl group-containing organopolysiloxane; (B) a mixture of components (B1) and (B2), where component (B1) is an organosilicon compound of 1 to 100 silicon atoms containing at least one phenylene structure and at least one silicon-bonded hydrogen atom per molecule, and component (B2) is an organohydrogenpolysiloxane containing an average of 2 to 4 silicon-bonded hydrogen atoms per molecule and having a viscosity of from 1 to 1,000 mPa·s at 25° C., but no phenylene structure in the molecule. The thermally conductive silicone composition further comprises (C) 400 to 3,500 parts by mass of a thermally conductive filler, (D) a siloxane macromonemer, and (E) a catalytic amount of a hydrosilylation reaction catalyst. A thermally conductive member comprising the thermally conductive silicone composition is also provided.

### CROSS-REFERENCE TO RELATED APPLICATIONS

This application claims priority to and all advantages of U.S. Provisional Application No. 63/435,019 filed on 23 Dec. 2022, the contents of which is incorporated herein by reference.

### FIELD OF THE DISCLOSURE

The present invention relates to a thermally conductive silicone composition having high thermal conductivity, excellent adhesion even to a substrate with poor adhesiveness (e.g., aluminum die casting material), and soft property after heating for an extended time. Also, the composition can be applied as solventless-type thermally conductive silicone composition which can be cured at room temperature.

### BACKGROUND

In recent years, with an increase in the degree of density and integration of hybrid ICs and printed circuit boards that carry transistors, ICs, memory elements, and other electronic components, and an increase in the capacity of secondary batteries (cell type), the thermally conductive silicone compositions consisting of organopolysiloxane and thermally conductive fillers such as aluminum oxide powder and zinc oxide powder have been widely used in order to efficiently dissipate heat generated from electronic and electrical devices such as electronic components and batteries. In particular, the thermally conductive silicone composition filled with a large amount of thermally conductive fillers has been proposed in order to cope with high heat dissipation.

Conventional thermally conductive silicone compositions having high thermal conductivity can be achieved by treating the surface of the thermally conductive filler with a hydrolyzable silane having a long-chain alkyl group, thereby imparting flexibility and heat-resistant mechanical properties to the molded product and improving its moldability and processability by decreasing the rise in viscosity, even if the thermally conductive silicone compositions are highly filled with the thermally conductive inorganic fillers.

However, in these thermally conductive silicone compositions, although a certain decrease in viscosity and improvement in moldability can be recognized, their fluidity is insufficient. As such, it is difficult to precisely apply to the highly refined structures of electric and electronic materials, and sufficient heat dissipation may not be achieved where the gap is generated between the electronic members that are supposed to release heat, thereby causing latent heat. In addition, where these electronic members require repairability corresponding to positioning, circuit rearrangement, and the like, the conventional thermally conductive silicone composition makes it easy for the thermally conductive cured product to adhere to the member. Therefore, it is difficult to peel off the thermally conductive cured product from the member without leaving any residue, which may deteriorate the yield during manufacturing and may hinder repair or reuse of electronic and electrical devices such as electronic components and batteries.

### BRIEF SUMMARY

A thermally conductive silicone composition is disclosed. The thermally conductive silicone composition comprises (A) 100 parts by mass of an alkenyl group-containing organopolysiloxane having a viscosity of from 10 to 100,000 mPa·s at 25° C. The thermally conductive silicone composition also comprises (B) a mixture of components (B1) and (B2). Component (B1) is an organosilicon compound of 1 to 100 silicon atoms containing at least one phenylene structure and at least one silicon-bonded hydrogen atom per molecule, and component (B2) is an organohydrogenpolysiloxane containing an average of 2 to 4 silicon-bonded hydrogen atoms per molecule and having a viscosity of from 1 to 1,000 mPa·s at 25° C., but no phenylene structure in the molecule. The total amount of silicon-bonded hydrogen atoms in component (B) is from 0.5 to 1.1 mol per 1 mol of alkenyl groups contained in component (A), and the molar ratio of silicon-bonded hydrogen atoms in component (B2) to component (B1) is from 0.1 to 1.0. The thermally conductive silicone composition further comprises (C) 400 to 3,500 parts by mass of a thermally conductive filler; and (D) a siloxane macromonemer represented by following formula (I) or formula (II):

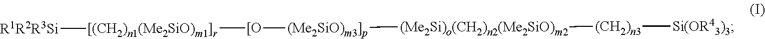

wherein each Me is a methyl group, R¹, R² and R³ are independently selected from an alkyl group having 1 to 20 carbon atoms, an alkenyl group having 2 to 4 carbon atoms, an alkoxy group having 1 to 3 carbon atoms, or —(OSiR⁷R⁸R⁹), wherein R⁷, R⁸ and R⁹ are each independently selected from an alkyl group having 1 to 4 carbon atoms, R⁴ is an alkyl group having 1 to 4 carbon atoms, n1, n2, m1, m3 and o are integers from 1 to 200, m2, n3, r and p are integers from 0 to 200, r and p are not 0 at the same time;

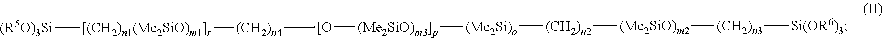

wherein R⁵ and R⁶ are an alkyl group having 1 to 4 carbon atoms, n1, m1, m3, o and n2 are integers from 1 to 200, n3, n4, m2, r and p are integers from 0 to 200, r and p are not 0 at the same time. Finally, the thermally conductive silicone composition comprises (E) a catalytic amount of a hydrosilylation reaction catalyst.

A thermally conductive member comprising the thermally conductive silicone composition is also provided, along with a heat dissipation structure comprising the thermally conductive member.

### Problem to be Solved

Conventionally, heat-generating components such as power transistors and thyristors have been subjected to heat generation, which degrades their characteristics, so measures have been taken to dissipate the heat and release it into the metal chassis of the equipment by installing heat sinks at the time of installation.

In recent years, reactors are increasingly required in the power control units of hybrid, electric, and fuel cell vehicles to boost the battery voltage and apply it to a motor. In addition, as power control units have become miniaturized, the reactor, one of the components, has also needed to be smaller, and its internal structure has been becoming more and more miniaturized and complex in recent years.

In addition, because of the high temperature inside the reactor, a high heat dissipation performance of at least 0.5 W/mK is required. By filling the reactor directly with heat-dissipating material, it is possible to increase the heat dissipation area from the entire reactor.

Therefore, potting properties and adhesion to an external case are becoming increasingly important. In particular, if adhesion to the case is insufficient, delamination will occur during subsequent use, causing a significant reduction in heat dissipation performance.

Aluminum die-casting is often used as the material for the external case, considering its formability and cost. However, aluminum die casting is a difficult substrate or adherend to obtain adhesion.

Therefore, it is important to develop products that exhibit high adhesive strength and cohesive breakdown rate.

### Means for Solving the Problem

As a result of intensive investigation, the present inventors have found that the problems described above can be resolved by a composition comprising:
(A) 100 parts by mass of an alkenyl group-containing organopolysiloxane having a viscosity of from 10 to 100,000 mPa·s at 25° C.;
(B) a mixture of components (B1) and (B2):
   (B1) an organosilicon compound of 1 to 100 silicon atoms containing at least one phenylene structure and at least one silicon-bonded hydrogen atom per molecule, and
   (B2) an organohydrogenpolysiloxane containing an average of 2 to 4 silicon-bonded hydrogen atoms per molecule and having a viscosity of from 1 to 1,000 mPa·s at 25° C., but no phenylene structure in the molecule,
   wherein the total amount of silicon-bonded hydrogen atoms in component (B) is from 0.5 to 1.1 mol per 1 mol of alkenyl groups contained in component (A), and the molar ratio of silicon-bonded hydrogen atoms in component (B1) per component (B2) is from 0.1 to 1.0;
(C) 400 to 3,500 parts by mass of a thermally conductive filler;
(D) a siloxane macromonemer represented by following formula (I) or formula (II)

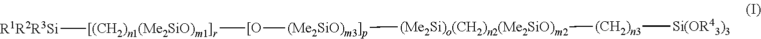

wherein each Me is a methyl group, R¹, R² and R³ are independently selected from an alkyl group having 1 to 20 carbon atoms, an alkenyl group having 2 to 4 carbon atoms, an alkoxy group having 1 to 3 carbon atoms, or —(OSiR⁷R⁸R⁹), wherein R⁷, R⁸ and R⁹ are each independently selected from an alkyl group having 1 to 4 carbon atoms, R⁴ is an alkyl group having 1 to 4 carbon atoms, n1, n2, m1, m3 and o are integers from 1 to 200, m2, n3, r and p are integers from 0 to 200, r and p are not 0 at the same time;

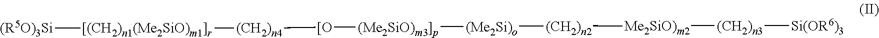

wherein R⁵ and R⁶ are an alkyl group having 1 to 4 carbon atoms, n1, m1, m3, o and n2 are integers from 1 to 200, n3, n4, m2, r and p are integers from 0 to 200, r and p are not 0 at the same time; and
(E) a catalytic amount of a hydrosilylation reaction catalyst

### Effect of the Invention

The thermally conductive silicone composition of the present invention has excellent thermal conductivity and adhesion to various substrates, including those known for having poor adhesiveness, like die cast aluminum, including after cure. In addition, the thermally conductive silicone composition after cure maintains soft properties after extended exposure to high temperatures. Further still, the thermally conductive silicone composition can be formulated as a solventless composition and can be cured at room temperature.

### DETAILED DESCRIPTION

The present disclosure provides a thermally conductive silicone composition (the “composition”). The composition and cured product have excellent physical properties, including thermal conductivity and adhesion to myriad different substrates, including those known for having poor adhesive properties. As such, the composition is particularly well suited for use in or as a thermally conductive member and/or heat dissipating structure. However, end uses of the composition and cured product formed therewith are not so limited.

The composition comprises (A) an alkenyl group-containing organopolysiloxane having a viscosity of from 10 to 100,000 mPa·s at 25° C. In some specific examples, component (A) has a viscosity in the range from 10 to 10,000, alternatively from 10 to 9,000, alternatively from 10 to 8,000, alternatively from 10 to 7,000, alternatively from 10 to 6,000, alternatively from 10 to 5,000, alternatively from 10 to 4,000, alternatively from 10 to 3,000, alternatively from 10 to 2,000, alternatively from 10 to 1,000, mPa·s at 25° C. Viscosity may be measured at 25° C. via a Brookfield LV DV-E viscometer with a spindle selected as appropriate to the viscosity of the substantially linear polyorganosiloxane, i.e., RV-1 to RV-7.

As understood by those of skill in the art, organopolysiloxanes comprise inorganic silicon-oxygen-silicon groups (i.e., —Si—O—Si—), with organosilicon and/or organic side groups attached to the silicon atoms in M, D, T, and/or Q siloxy units. Organopolysiloxanes are typically characterized in terms of the number, type, and/or proportion of [M], [D], [T], and/or [Q] units/siloxy groups, which each represent structural units of individual functionality present in organopolysiloxane resins. In particular, [M] represents a monofunctional unit of general formula R″₃SiO_{1/2}; [D] represents a difunctional unit of general formula R″₂SiO_{2/2}; [T] represents a trifunctional unit of general formula R″SiO_{3/2}; and [Q] represents a tetrafunctional unit of general formula SiO_{4/2}, as shown by the general structural moieties below:

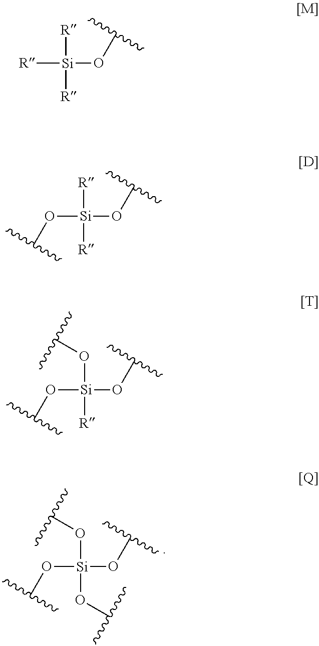

In these general structural moieties, each R″ is independently a monovalent or polyvalent substituent. As understood in the art, specific substituents suitable for each R″ are not particularly limited (e.g., may be monoatomic or polyatomic, organic or inorganic, linear or branched, substituted or unsubstituted, aromatic, aliphatic, saturated or unsaturated, etc., as well as various combinations thereof).

One of skill in the art understands how [M], [D], [T] and [Q] units, and their relative proportions (i.e., molar fractions) influence and control the structure of siloxanes, and that polysiloxanes in general may be monomeric, polymeric, oligomeric, linear, branched, cyclic, and/or resinous depending on the selection of [M], [D], [T] and/or [Q] units therein. For example, [T] units and/or [Q] units are present in organopolysiloxane resins, whereas linear organopolysiloxanes are typically free from such [T] units and/or [Q] units.

In specific embodiments, component (A) is free form Q units. In these or other embodiments, component (A) is free from both T and Q units. Specifically, component (A) is typically linear. The alkenyl groups are silicon-bonded, and can be present in terminal locations (i.e., in one or more M units), and/or be present in pendent locations (i.e., in one or more D units).

For example, component (A) may have the average formula: R_{a′}SiO_{(4-a′)/2}, where each R is independently selected from substituted or unsubstituted hydrocarbyl groups, with the proviso that at least two of R are independently alkenyl groups, and where subscript a′ is selected such that 1.9≤a′≤2.2.

In general, hydrocarbyl groups suitable for R may independently be linear, branched, cyclic, or combinations thereof. Cyclic hydrocarbyl groups encompass aryl groups as well as saturated or non-conjugated cyclic groups. Cyclic hydrocarbyl groups may independently be monocyclic or polycyclic. Linear and branched hydrocarbyl groups may independently be saturated or unsaturated. One example of a combination of a linear and cyclic hydrocarbyl group is an aralkyl group. General examples of hydrocarbyl groups include alkyl groups, aryl groups, alkenyl groups, halocarbon groups, and the like, as well as derivatives, modifications, and combinations thereof. Examples of suitable alkyl groups include methyl, ethyl, propyl (e.g., isopropyl and/or n-propyl), butyl (e.g., isobutyl, n-butyl, tert-butyl, and/or sec-butyl), pentyl (e.g., isopentyl, neopentyl, and/or tert-pentyl), hexyl, hexadecyl, octadecyl as well as branched saturated hydrocarbon groups having from 6 to 18 carbon atoms. Examples of suitable non-conjugated cyclic groups include cyclobutyl, cyclohexyl, and cycloheptyl groups. Examples of suitable aryl groups include phenyl, tolyl, xylyl, naphthyl, benzyl, and dimethyl phenyl. Examples of suitable alkenyl groups include vinyl, allyl, propenyl, isopropenyl, butenyl, isobutenyl, pentenyl, heptenyl, hexenyl, octenyl, hexadecenyl, octadecenyl and cyclohexenyl groups.

Examples of suitable monovalent halogenated hydrocarbon groups (i.e., halocarbon groups) include halogenated alkyl groups, aryl groups, and combinations thereof. Examples of halogenated alkyl groups include the alkyl groups described above where one or more hydrogen atoms is replaced with a halogen atom such as F or Cl. Specific examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl groups, as well as derivatives thereof. Examples of halogenated aryl groups include the aryl groups described above where one or more hydrogen atoms is replaced with a halogen atom, such as F or Cl. Specific examples of halogenated aryl groups include chlorobenzyl and fluorobenzyl groups.

In specific embodiments, each R is independently selected from alkyl groups having from 1 to 32, alternatively from 1 to 28, alternatively from 1 to 24, alternatively from 1 to 20, alternatively from 1 to 16, alternatively from 1 to 12, alternatively from 1 to 8, alternatively from 1 to 4, alternatively 1, carbon atoms, and from ethylenically unsaturated (i.e., alkenyl and/or alkynyl groups) groups having from 2 to 32, alternatively from 2 to 28, alternatively from 2 to 24, alternatively from 2 to 20, alternatively from 2 to 16, alternatively from 2 to 12, alternatively from 2 to 8, alternatively from 2 to 4, alternatively 2, carbon atoms.

“Alkenyl” means an acyclic, branched or unbranched, monovalent hydrocarbon group having one or more carbon-carbon double bonds. Specific examples thereof include vinyl groups, allyl groups, hexenyl groups, and octenyl groups. Various examples of ethylenically unsaturated groups include CH₂═CH—, CH₂═CHCH₂—, CH₂═CH(CH₂)₄—, CH₂═CH(CH₂)₆—, CH₂═C(CH₃)CH₂—, H₂C═C(CH₃)—, H₂C═C(CH₃)—, H₂C═C(CH₃)CH₂—, H₂C═CHCH₂CH₂—, H₂C═CHCH₂CH₂CH₂—. Typically, when R is an ethylenically unsaturated group, the ethylenic unsaturation is terminal in R. As understood in the art, ethylenic unsaturation may be referred to as aliphatic unsaturation.

When the (A) organopolysiloxane is substantially linear, alternatively is linear, the at least two aliphatically unsaturated groups may be bonded to silicon atoms in pendent positions, terminal positions, or in both pendent and terminal locations.

When the (A) organopolysiloxane is the substantially linear polyorganosiloxane, the (B) organopolysiloxane can be exemplified by a dimethylpolysiloxane capped at both molecular terminals with dimethylvinylsiloxy groups, a methylphenylpolysiloxane capped at both molecular terminals with dimethylvinylsiloxy groups, a copolymer of a methylphenylsiloxane and dimethylsiloxane capped at both molecular terminals with dimethylvinylsiloxy groups, a copolymer of a methylvinylsiloxane and a methylphenylsiloxane capped at both molecular terminals with dimethylvinylsiloxy groups, a copolymer of a methylvinylsiloxane and diphenylsiloxane capped at both molecular terminals with dimethylvinylsiloxy groups, a copolymer of a methylvinylsiloxane, methylphenylsiloxane, and dimethylsiloxane capped at both molecular terminals with dimethylvinylsiloxy groups, a copolymer of a methylvinylsiloxane and a methylphenylsiloxane capped at both molecular terminals with trimethylsiloxy groups, a copolymer of a methylvinylsiloxane and diphenylsiloxane capped at both molecular terminals with trimethylsiloxy groups, and a copolymer of a methylvinylsiloxane, methylphenylsiloxane, and a dimethylsiloxane capped at both molecular terminals with trimethylsiloxy groups.

In specific embodiments, component (A) is selected from the group consisting of:
i) dimethylvinylsiloxy-terminated polydimethylsiloxane,
ii) dimethylvinylsiloxy-terminated poly(dimethylsiloxane/methylvinylsiloxane),
iii) dimethylvinylsiloxy-terminated polymethylvinylsiloxane,
iv) trimethylsiloxy-terminated poly(dimethylsiloxane/methylvinylsiloxane),
v) trimethylsiloxy-terminated polymethylvinylsiloxane,
vi) dimethylvinylsiloxy-terminated poly(dimethylsiloxane/methylvinylsiloxane),
vii) dimethylvinylsiloxy-terminated poly(dimethylsiloxane/methylphenylsiloxane),
viii) dimethylvinylsiloxy-terminated poly(dimethylsiloxane/diphenylsiloxane),
ix) phenyl, methyl, vinyl-siloxy-terminated polydimethylsiloxane,
x) dimethylhexenylsiloxy-terminated polydimethylsiloxane,
xi) dimethylhexenylsiloxy-terminated poly(dimethylsiloxane/methylhexenylsiloxane),
xii) dimethylhexenylsiloxy-terminated polymethylhexenylsiloxane,
xiii) trimethylsiloxy-terminated poly(dimethylsiloxane/methylhexenylsiloxane),
xiv) trimethylsiloxy-terminated polymethylhexenylsiloxane
xv) dimethylhexenyl-siloxy terminated poly(dimethylsiloxane/methylhexenylsiloxane),
xvi) dimethylvinylsiloxy-terminated poly(dimethylsiloxane/methylhexenylsiloxane), and
xvii) a combination thereof.

Component (A) can comprise one or more types of alkenyl group-containing organopolysiloxanes. The molecular structure of the alkenyl group-containing organopolysiloxane of component (A) is not particularly limited, and examples include linear, branched, cyclic, and three-dimensional network structures, and combinations thereof. Component (A) can comprise only linear alkenyl group-containing organopolysiloxanes, only alkenyl group-containing organopolysiloxanes having a branched structure, or mixtures of linear organopolysiloxanes and alkenyl group-containing organopolysiloxanes having a branched structure.

The composition comprises component (A) in an amount of 100 parts by weight.

The composition also comprises (B) a mixture of components (B1) and (B2). Typically, component (B) is a premixture, i.e., components (B1) and (B2) are mixed to give component (B) prior to combining component (B) with the other components of the composition. However, in other embodiments, component (B) may be formed in situ by mixing components (B1) and (B2) in the presence of one or more other components of the composition.

Component (B1) is an organosilicon compound having from 1 to 100 silicon atoms, alternatively from 2 to 30 silicon atoms, containing at least one phenylene structure and at least one silicon-bonded hydrogen atom (i.e., SiH group) per molecule. The term “phenylene structure” used herein encompasses aromatic ring structures having a valence of 2 to 6, alternatively 2 to 4, such as phenylene, naphthalene and anthracene structures. Component (B1) is effective for imparting adhesion to the composition. In this sense, component (B1) may be referred to as a tackifier.

Examples of component (B1) include organosilicon compounds having from 1 to 100 silicon atoms, alternatively from 2 to 30 silicon atoms, alternatively from 2 to 20 silicon atoms, and alternatively from 4 to 10 silicon atoms. The organosilicon compound of component (B1) can be a linear or cyclic organosiloxane oligomer or organosilane having at least one, typically 1 to 20, alternatively 2 to 10 SiH groups (i.e., silicon-bonded hydrogen atoms) per molecule, have at least one, typically 1 to 4 phenylene structures, and may further contain one or more functional groups including epoxy groups such as glycidoxy, alkoxysilyl groups such as trimethoxysilyl, triethoxysilyl and methyldimethoxysilyl, ester, acrylic, methacrylic, carboxylic anhydride, isocyanate, amino or amide groups.

In specific embodiments, component (B1) has the following structure:

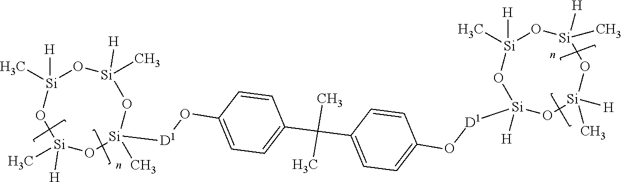

where each subscript n is independently an integer of from 1 to 3, and each D¹ is independently selected from a divalent hydrocarbon group and a covalent bond. When D¹ is a covalent bond, only an oxygen atom is present between the phenylene moiety and the cyclic siloxane moiety. In certain embodiments, each D¹ is a covalent bond. In other embodiments, each D¹ is a divalent hydrocarbon group having from 1 to 8, alternatively 1 to 7, alternatively 1 to 6, alternatively from 1 to 5, alternatively from 1 to 4, alternatively from 1 to 3, carbon atoms.

Examples of organosilicon compounds suitable for component (B1) are illustrated as follows:

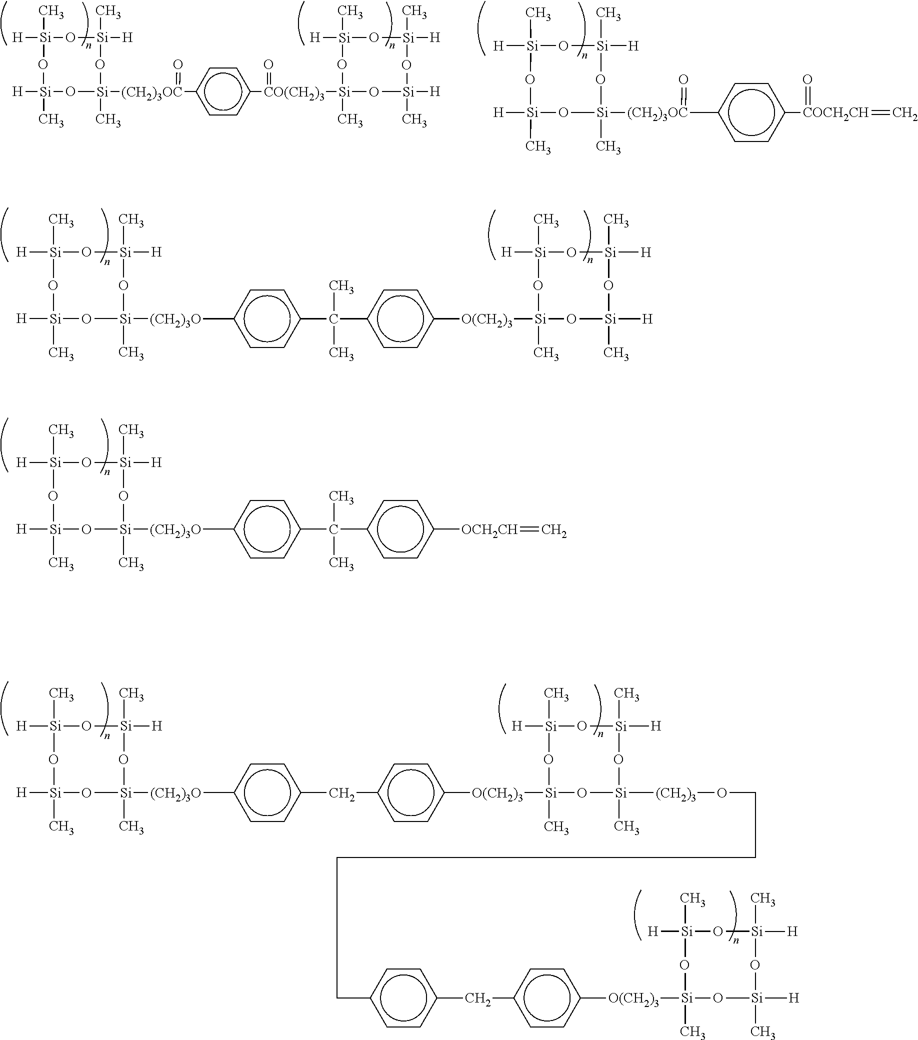

wherein n is independently an integer of 1 to 4. In the structures above, any of the O(CH2)3 moieties that bridge each phenylene moiety and each cyclic siloxane moiety can be replaced with, for example, with O, OCH2, O(CH2)2, etc.

Additional examples of component (B1) are as follows:

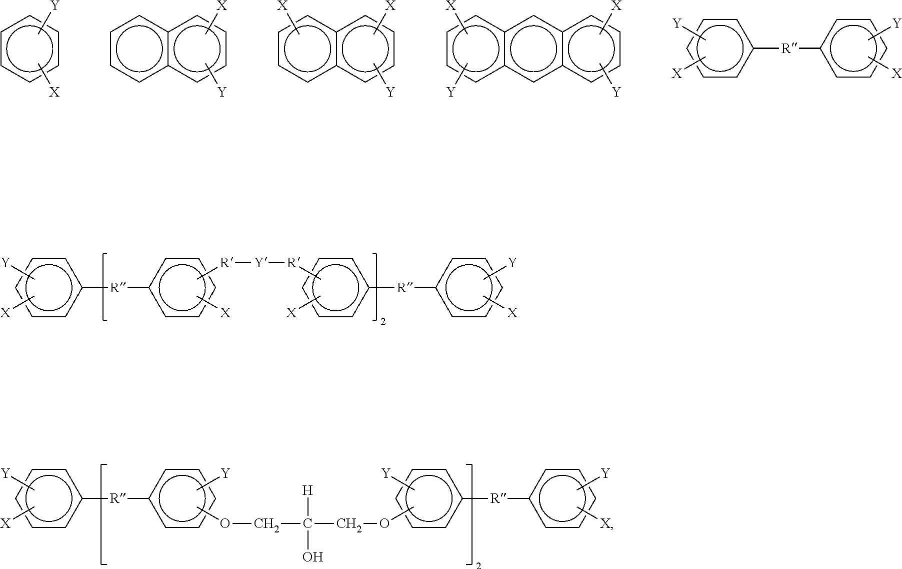

wherein X is:

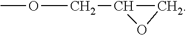

In the examples above, Y is either of the following groups:

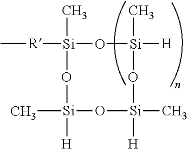

wherein n is an integer of 1 to 4; and

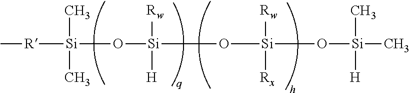

wherein R′ is a group selected from:

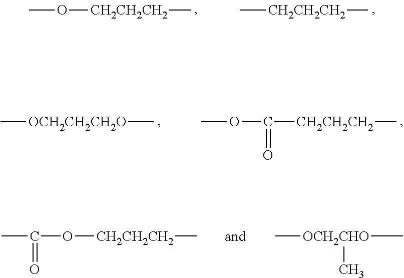

wherein R_{w} and Rₓ each are independently a substituted or unsubstituted, monovalent hydrocarbon group, wherein q is an integer from 1 to 50, alternatively from 1 to 20, wherein h is an integer from 0 to 100, alternatively from 1 to 50, wherein R″ is a group selected from:

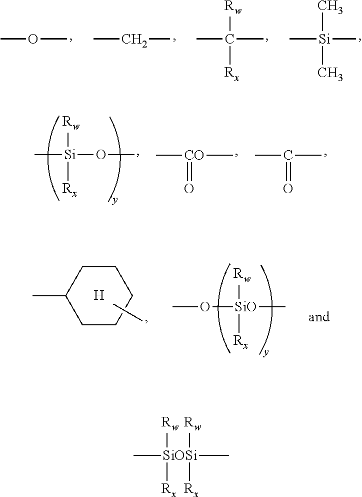

wherein R_{w} and Rₓ are as defined above, and y is an integer from 0 to 100, wherein Y′ is either of the following groups:

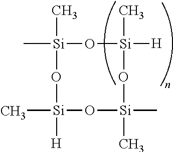

wherein n is an integer of 1 to 4, and

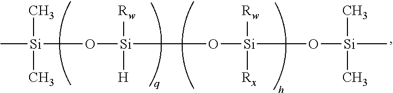

wherein R_{w}, Rₓ, q, and h are as defined above, and z is an integer from 1 to 10.

Suitable optionally substituted monovalent hydrocarbon groups represented by R_{w} and Rₓ include those groups described above for R. The hydrocarbyl groups described above for R may be substituted with an alkoxy, acrylic, methacrylic, acryloyl, methacryloyl, amino, or alkylamino radical in R_{w} and/or Rₓ.

Additional examples of component (B1) include the above-illustrated organosilicon compounds having further introduced therein an alkoxysilyl group such as trimethoxysilyl, triethoxysilyl or methyldimethoxysilyl, acrylic, methacrylic, ester, carboxylic anhydride, isocyanate, amino or amide group.

The content of silicon-bonded hydrogen atoms (SiH content) of the organosilicon compound of component (B1) is typically 0.001 to 0.01 mol/g, more preferably 0.002 to 0.01 mol/g.

The organosilicon compound of component (B1) is generally free of any alkenyl groups. When an alkenyl-containing organosilicon compound is used as component (B1), it should be used in such amounts that a molar ratio of total SiH groups in the composition to total silicon-bonded alkenyl groups in the composition is from 1.0 to 5.0, alternatively from 1.2 to 4.0, and alternatively from 1.5 to 3.0.

Component (B2) is an organohydrogenpolysiloxane containing an average of 2 to 4 silicon-bonded hydrogen atoms per molecule and having a viscosity of from 1 to 1,000 mPa·s at 25° C. Component (B2) has no phenylene structure in the molecule, unlike component (B1). Component (B2) functions as a crosslinker or chain extender for component (A) in that SiH groups in its molecule undergo hydrosilylation or addition reaction with silicon-bonded alkenyl groups in component (A). The organohydrogenpolysiloxane as component (B2) is typically linear.

In certain embodiments, component (B2) includes silicon-bonded hydrogen atoms only on its molecular terminals. Said differently, in such embodiments, component (B2) does not include silicon-bonded hydrogen atoms in pendant positions, i.e., bonded to silicon atoms in D siloxy units. In other embodiments, component (B2) includes silicon-bonded hydrogen atoms only on pendent positions, i.e., bonded to silicon atoms in D siloxy units. Said differently, in such embodiments, component (B2) does not include silicon-bonded hydrogen atoms in terminal positions, i.e., bonded to silicon atoms in M siloxy units. In yet other embodiments, component (B2) includes silicon-bonded hydrogen atoms in both pendent and terminal positions.

In specific embodiments, component (B2) has the average unit formula: (HR¹⁰₂SiO_{1/2}) (R¹⁰₂SiO_{2/2})_{n′}(HR¹⁰₂SiO_{1/2}), where each R¹⁰ is independently selected hydrocarbyl group, alternatively is an independently selected alkyl group, and subscript n′ is selected to give a viscosity of component (B2) at 25° C. of from 1 to 1,000 mPa·s, alternatively from 10 to 500 mPa·s. In other embodiments, the linear organohydrogenpolysiloxane has average unit formula: (R¹⁰₃SiO_{1/2})(R¹⁰₂SiO_{2/2})_{x′}(HR¹⁰SiO_{2/2})_{y′}(R¹⁰₃SiO_{1/2}), where each R¹⁰ is independently selected hydrocarbyl group, alternatively an independently selected alkyl group, and subscript y′ is 2 to 4, and subscript x′ is selected to give a viscosity of component (B) at 25° C. of from 1 to 1,000 mPa·s, alternatively from 10 to 500 mPa·s.

In another specific embodiment, component (B2) has the average formula:

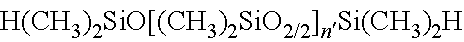

where n′ is as defined above. In a different specific embodiment, component (B2) has the average formula:

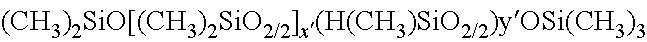

where x′ and y′ are as defined above. Component (B2) may comprise a combination or two or more different organohydrogenpolysiloxanes that differ in at least one property such as structure, molecular weight, degree of polymerization, viscosity, etc.

The total amount of silicon-bonded hydrogen atoms in the component (B) (including those attributable to both component (B1) and component (B2)) is from 0.5 to 1.1 mol, alternatively from 0.6 to 1.1 mol, alternatively from 0.7 to 1.1 mol, per 1 mol of alkenyl groups contained in component (A). In addition, the molar ratio of silicon-bonded hydrogen atoms in component (B1) to silicon-bonded hydrogen atoms in component (B2) is from 0.1 to 1.0, alternatively from 0.10 to 0.75, alternatively from 0.15 to 0.60. When the reaction ratio for component (B) or the molar ratio of SiH of (B1)/SiH of (B2) is out of said ranges, the soft property in the composition after heating might be impaired or insufficient.

The composition additionally comprises (C) from 400 to 3,500 parts by mass of a thermally conductive filler.

The thermally conductive filler (C) is for imparting thermal conductivity to the composition and a thermally conductive member obtained by curing the composition. Such a component (C) is typically at least one or more type of powder and/or fiber selected from the group consisting of a pure metal, alloy, metal oxide, metal hydroxide, metal nitride, metal carbide, metal silicide, carbon, soft magnetic alloy and a ferrite. Of these, metal powder, metal oxide powder, metal nitride powder, or carbon powder is most typical.

All or a part of the thermally conductive filler (C) is optionally but typically subjected to a surface treatment with an alkoxysilane as a component (G) described below. Furthermore, those powders and/or fibers which have been treated with various surface treatment agents known as coupling agents may be used separately or together with the component (G). Examples of the a surface treatment agent for treating the powder and/or fiber of the component (C) include surfactants, other silane coupling agents, aluminum-based coupling agents, silicone-based surface treatment agents, and the like, in addition to component (G).

Examples of pure metals include bismuth, lead, tin, antimony, indium, cadmium, zinc, silver, copper, nickel, aluminum, iron and metallic silicon. Examples of the alloy include an alloy consisting of two or more metals selected from the group consisting of bismuth, lead, tin, antimony, indium, cadmium, zinc, silver, aluminum, iron and metallic silicon. Examples of the metal oxide include alumina, zinc oxide, silicon oxide, magnesium oxide, beryllium oxide, chromium oxide, and titanium oxide. Examples of metal hydroxide include magnesium hydroxide, aluminum hydroxide, barium hydroxide, and calcium hydroxide. Examples of metal nitride include boron nitride, aluminum nitride and silicon nitride. Examples of metal carbide include silicon carbide, boron carbide and titanium carbide. Examples of metal silicide include magnesium silicide, titanium silicide, zirconium silicide, tantalum silicide, niobium silicide, chromium silicide, tungsten silicide, and molybdenum silicide. Examples of the carbon include diamond, graphite, fullerene, carbon nanotube, graphene, activated carbon, and monolithic carbon black. Examples of soft magnetic alloy include an Fe—Si alloy, Fe—Al alloy, Fe—Si—Al alloy, Fe—Si—Cr alloy, Fe—Ni alloy, Fe—Ni—Co alloy, Fe—Ni—Mo alloy, Fe—Co alloy, Fe—Si—Al—Cr alloy, Fe—Si—B alloy and an Fe—Si—Co—B alloy. Examples of ferrite include a Mn—Zn ferrite, Mn—Mg—Zn ferrite, Mg—Cu—Zn ferrite, Ni—Zn ferrite, Ni—Cu—Zn ferrite and a Cu—Zn ferrite.

[In specific embodiments, component (C) comprises a silver powder, aluminium powder, aluminium oxide powder, zinc oxide powder, aluminium nitride powder or graphite. When the composition requires electrical insulation, a metal oxide-based powder or a metal nitride-based powder is preferably used; particularly preferably an aluminium oxide powder, a zinc oxide powder, or an aluminium nitride powder.

The form of the component (C) is not particularly limited, and examples thereof include spherical, needle-like, disk-like, rod-like, or irregular form, but is typically spherical or irregular form. The average particle size of component (C) is not particularly limited but is typically in the range of 0.01 to 100 μm, and alternatively in the range of 0.01 to 50 μm.

In specific embodiments, component (C) comprises (C1) a lamellar boron nitride powder having an average particle size of 0.1 to 30 μm, (C2) a granular boron nitride powder having an average particle size of 0.1 to 50 μm, (C3) a spherical and/or crushed aluminum oxide powder having an average particle size of 0.01 to 50 μm, or (C4) a spherical and/or crushed graphite having an average particle size of 0.01 to 50 μm; or a mixture of two or more types thereof. A mixture of two or more types of spherical and crushed aluminum oxide powders having an average particle size of 0.01 to 50 μm is most typical. Combination of an aluminum oxide powder having a larger particle size with an aluminum oxide powder having a smaller particle size in a proportion according to a closest packing theory distribution curve can especially improve the filling efficiency, reduce the viscosity and increase the thermal conductivity.

The content of component (C) in the composition is in the range of from 400 to 3,500 parts by mass, alternatively in the range of 400 to 3,000 parts by mass, per 100 parts by mass of component (A). This is because the thermal conductivity of the obtained composition tends to be insufficient if the content of the component (C) is lower than the lower limit of the aforementioned range, and if the content of the component (C) exceeds the upper limit of the aforementioned range, the viscosity of the obtained composition significantly increases even when the component (G) is blended or used for the surface treatment of the component (C), and hence, the handleability, the gap filling ability and the like tend to deteriorate.

Further, the composition comprises (D) a siloxane macromonemer represented by following formula (I) and/or formula (II). Formula (I) is as follows:

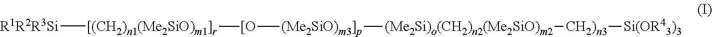

wherein each Me is a methyl group, R¹, R² and R³ are independently selected from an alkyl group having 1 to 20 carbon atoms, an alkenyl group having 2 to 4 carbon atoms, an alkoxy group having 1 to 3 carbon atoms, or —(OSiR⁷R⁸R⁹), wherein R⁷, R⁸ and R⁹ are each independently selected from an alkyl group having 1 to 4 carbon atoms, R⁴ is an alkyl group having 1 to 4 carbon atoms, n1, n2, m1, m3 and o are integers from 1 to 200, m2, n3, r and p are integers from 0 to 200, r and p are not 0 at the same time.

Formula (II) for component (D) is as follows:

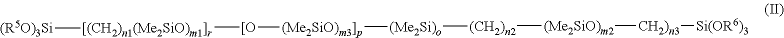

wherein R⁵ and R⁶ are an alkyl group having 1 to 4 carbon atoms, n1, m1, m3, o and n2 are integers from 1 to 200, n3, n4, m2, r and p are integers from 0 to 200, r and p are not 0 at the same time.

Component (D) can in certain embodiments be considered a surface treatment agent. For example, without wishing to be bound by a theory, it is considered that the formula (I) compound can easily bind to the surface of a filler, such as component (C), through chemical bonding and/or physical bonding and give better affinity to the filler with organopolysiloxanes, thus rendering the composition flowable and with good processability even when a large amount of filler is loaded.

Specific examples of the compound represented by Formula (I) include, but are not limited to:

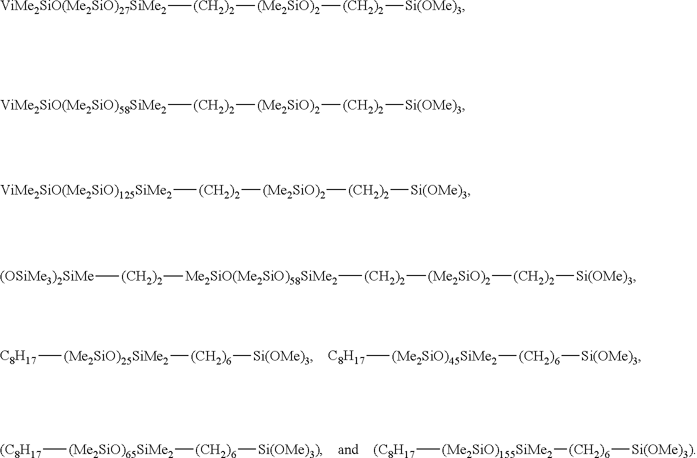

Specific examples of the compound represented by Formula (II) include, but are not limited to:

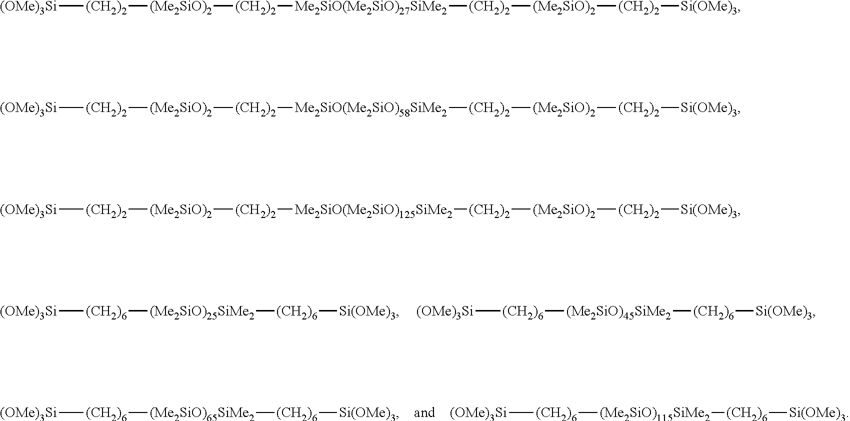

In certain embodiments, component (D) comprises, alternatively consists of, compounds of Formula (I) to the exclusion of those of Formula (II). In other embodiments, component (D) comprises, alternatively consists of, compounds of Formula (II) to the exclusion of those of Formula (I). In yet other embodiments, component (D) comprises a blend of compounds of Formulas (I) and Formula (II). In such embodiments, i.e., where a blend is utilized, a molar ratio of compounds of Formula (I) to compounds of Formula (II) ((I)/(II)) is from 2 to 15, and alternatively from 6 to 12. Further still, component (D) may comprise a combination or two or more different compounds failing within Formula (I), within Formula (II), or both.

Component (D) provides desirably processability of the composition despite the composition comprising a large amount of the thermally conductive filler (C). Since the compounds of formulas (I) and (II) have terminal alkoxy groups, component (D) can react with hydroxyl groups on the surface of the filler the thermally conductive filler (C). The amount of component (D) in the composition is from 0.01 to 20 weight %, alternatively from 0.1 to 10 weight % based on the total weight of the composition. In specific embodiments, the amount of component (D) in the composition is from 0.005 to 10 parts by weight based on 100 parts by weight of component (A).

The composition further comprises (E) a catalytic amount of a hydrosilylation reaction catalyst. One of skill in the art can readily determine a catalytic amount based on the number of reactive groups in other components of the composition and other reaction parameters. The hydrosilylation-reaction catalyst (E) is not limited and may be any known hydrosilylation-reaction catalyst for catalyzing hydrosilylation reactions. Combinations of different hydrosilylation-reaction catalysts may be utilized as component (E).

The hydrosilylation-reaction catalyst may be in or on a solid carrier. Examples of carriers include activated carbons, silicas, silica aluminas, aluminas, zeolites and other inorganic powders/particles (e.g., sodium sulphate), and the like. The (E) hydrosilylation-reaction catalyst may also be disposed in a vehicle, e.g., a solvent which solubilizes the (E) hydrosilylation-reaction catalyst, alternatively a vehicle which merely carries, but does not solubilize, the (E) hydrosilylation-reaction catalyst. Such vehicles are known in the art.

In specific embodiments, the (E) hydrosilylation-reaction catalyst comprises platinum. In these embodiments, the (E) hydrosilylation-reaction catalyst is exemplified by, for example, platinum black, compounds such as chloroplatinic acid, chloroplatinic acid hexahydrate, a reaction product of chloroplatinic acid and a monohydric alcohol, platinum bis(ethylacetoacetate), platinum bis(acetylacetonate), platinum chloride, and complexes of such compounds with olefins or organopolysiloxanes, as well as platinum compounds microencapsulated in a matrix or core-shell type compounds. Microencapsulated hydrosilylation catalysts and methods of their preparation are also known in the art, as exemplified in U.S. Pat. Nos. 4,766,176 and 5,017,654, which are incorporated by reference herein in their entireties.

Complexes of platinum with organopolysiloxanes suitable for use as the hydrosilylation-reaction catalyst (E) include 1,3-divinyl-1,1,3,3-tetramethyldisiloxane; 1,3,5,7-tetramethyl-1,3,5,7-tetravinylcyclotetrasiloxane; alkenyl siloxanes obtained by substituting a portion of methyl groups of the alkenylsiloxanes with an ethyl group, a phenyl group, or the like; and alkenylsiloxanes obtained by substituting a portion of vinyl groups of these alkenylsiloxanes with an allyl group, a hexenyl group, or the like. In particular, 1,3-divinyl-1,1,3,3-tetramethyldisiloxane is typically used because of the favorable stability of this platinum-alkenylsiloxane complex, and is generally added in the form of a complex alkenylsiloxane solution. These complexes may be microencapsulated in a resin matrix. Alternatively, the hydrosilylation-reaction catalyst (E) may comprise 1,3-diethenyl-1,1,3,3-tetramethyldisiloxane complex with platinum. The hydrosilylation-reaction catalyst (E) may be prepared by a method comprising reacting chloroplatinic acid with an aliphatically unsaturated organosilicon compound such as divinyltetramethyldisiloxane, or alkene-platinum-silyl complexes.

The hydrosilylation-reaction catalyst (E) may also, or alternatively, be a photoactivatable hydrosilylation-reaction catalyst, which may initiate curing via irradiation and/or heat. The photoactivatable hydrosilylation-reaction catalyst can be any hydrosilylation-reaction catalyst capable of catalyzing the hydrosilylation reaction, particularly upon exposure to radiation having a wavelength of from 150 to 800 nanometers (nm).

Specific examples of photoactivatable hydrosilylation-reaction catalysts suitable for the hydrosilylation-reaction catalyst (E) include, but are not limited to, platinum(II) β-diketonate complexes such as platinum(II) bis(2,4-pentanedioate), platinum(II) bis(2,4-hexanedioate), platinum(II) bis(2,4-heptanedioate), platinum(II) bis(1-phenyl-1,3-butanedioate, platinum(II) bis(1,3-diphenyl-1,3-propanedioate), platinum(II) bis(1,1,1,5,5,5-hexafluoro-2,4-pentanedioate); (η-cyclopentadienyl)trialkylplatinum complexes, such as (Cp)trimethylplatinum, (Cp)ethyldimethylplatinum, (Cp)triethylplatinum, (chloro-Cp)trimethylplatinum, and (trimethylsilyl-Cp)trimethylplatinum, where Cp represents cyclopentadienyl; triazene oxide-transition metal complexes, such as Pt[C₆H₅NNNOCH₃]₄, Pt[p-CN—C₆H₄NNNOC₆H₁₁]₄, Pt[p-H₃COC₆H₄NNNOC₆H₁₁]₄, Pt[p-CH₃(CH₂)ₓ—C₆H₄NNNOCH₃]₄, 1,5-cyclooctadiene·Pt[p-CN—C₆H₄NNNOC₆H₁₁]₂, 1,5-cyclooctadiene·Pt[p-CH₃O—C₆H₄NNNOCH₃]₂, [(C₆H₅)₃P]₃Rh[p-CN—C₆H₄NNNOC₆H₁₁], and Pd[p-CH₃(CH₂)ₓ—C₆H₄NNNOCH₃]₂, where x is 1, 3, 5, 11, or 17; (η-diolefin) (σ-aryl) platinum complexes, such as (η⁴-1,5-cyclooctadienyl)diphenylplatinum, η⁴-1,3,5,7-cyclooctatetraenyl)diphenylplatinum, (η⁴-2,5-norboradienyl)diphenylplatinum, (η⁴-1,5-cyclooctadienyl)bis-(4-dimethylaminophenyl) platinum, (η⁴-1,5-cyclooctadienyl)bis-(4-acetylphenyl) platinum, and (η⁴-1,5-cyclooctadienyl)bis-(4-trifluormethylphenyl) platinum. Typically, the photoactivatable hydrosilylation-reaction catalyst is a Pt(II) β-diketonate complex and more typically the catalyst is platinum(II) bis(2,4-pentanedioate).

The hydrosilylation-reaction catalyst (E) is present in the composition in a catalytic amount, i.e., an amount or quantity sufficient to promote curing thereof at desired conditions. The hydrosilylation-reaction catalyst can be a single hydrosilylation-reaction catalyst or a mixture comprising two or more different hydrosilylation-reaction catalysts.

The catalytic amount of the hydrosilylation-reaction catalyst (E) may be an amount in which metal atoms are in the range of 0.01 to 500 ppm, 0.01 to 100 ppm, or 0.01 to 50 ppm in terms of mass units relative to the entire composition.

In certain embodiments, the composition further comprises (F) a heat resistance imparting agent to improve the heat resistance of the thermally conductive silicone composition and the cured product thereof. Component (F) is not particularly limited provided that component (F) is selected to impart heat resistance to the composition and the cured product thereof. Examples thereof include metal oxides, such as iron oxide, titanium oxide, cerium oxide, magnesium oxide, aluminum oxide and zinc oxide; metal hydroxides, such as cerium hydroxide; phthalocyanine compounds; carbon black; cerium silanolate; cerium fatty acid salts; reaction products of organopolysiloxanes and cerium carboxylates. Phthalocyanine compounds are typically utilized, for example, an additive selected from the group consisting of a metal-free phthalocyanine compound and a metal-containing phthalocyanine compound, such as that disclosed in JP2014-503680A, which is incorporated by reference herein. Among the metal-containing phthalocyanine compounds, a copper phthalocyanine compound is most typical. A specific and non-limiting heat-resistance-imparting agent is 29H, 31H-phthalocyaninato (2-)-N29, N30, N31, N32 copper. Such phthalocyanine compounds are commercially available, for example, STAN-TONE™ 40SP03 from PolyOne Corporation (Avon Lake, Ohio, USA).

Blends of different heat resistance imparting agents may be utilized together as component (F). The amount of the component (F) may be in the range of from 0.01 to 5.0 mass % of the total composition. It may be in the range of from 0.05 to 0.2 mass % and 0.07 to 0.1 mass %.

In certain embodiments, the composition further comprises (G) an alkoxysilane. The alkoxysilane includes an alkyl group having 6 or more carbon atoms. For example, the alkyl group having 6 or more carbon atoms may be an alkyl group such as hexyl group, octyl group, dodecyl group, tetradecyl group, hexadecyl group, and octadecyl group, and an aralkyl group such as benzyl group and phenylethyl group. Said differently, aralkyl groups are considered alkyl groups for purposes of component (G). The alkyl group having 6 to 20 carbon atoms is particularly preferred. In the case of an alkoxysilane having an alkyl group having less than 6 carbon atoms, the effect of reducing the viscosity of the composition is insufficient, so the viscosity of the composition may increase and the desired fluidity and gap filling ability may not be achieved. Further, when an alkoxysilane having an alkyl group having 20 or more carbon atoms is used, the compatibility may deteriorate depending on the type of the component (A) in addition to being inferior in industrial suppliability.

In certain embodiments, component (G) is represented by the following structural formula: YₙSi(OR)₄₋ₙ, wherein Y is an alkyl group having 6 to 18 carbon atoms, R is an alkyl group having 1 to 5 carbon atoms, and n is 1 or 2. Examples of the OR group include a methoxy group, an ethoxy group, a propoxy group, and a butoxy group.

Specific examples of suitable alkoxysilanes for component (G) include C₆H₁₃Si(OCH₃)₃, C₈H₁₇Si(OC₂H₅)₃, C₁₀H₂₁Si(OCH₃)₃, C₁₁H₂₃Si(OCH₃)₃, C₁₂H₂₅Si(OCH₃)₃, C₁₄H₂₉Si(OC₂H₅)₃, and the like.

The amount of the component (G) used is from 0.1 to 2.0 mass % relative to the component (C). If the amount is less than the lower limit of the aforementioned range, the effect of reducing the viscosity of the composition may be insufficient. If the amount of the component (G) used exceeds the upper limit of the aforementioned range, the effect of reducing the viscosity may be saturated, and the alkoxysilane may be further separated, resulting in reduced storage stability of the composition. Component (G), if utilized, may comprise a combination or two or more different organopolysiloxane resins that differ in at least one property such as structure, molecular weight, monovalent groups bonded to silicon atoms, etc.

In various embodiments, component (G) is blended in the form such that the component (C) is surface treated with the component (G). It is desirable that at least a part of the component (C) is surface treated with component (G) from the viewpoint of improving the fluidity and gap filling ability of the composition. When the component (G) is used as a surface treatment agent, the amount thereof is typically from 0.15 to 1.2 mass %, alternatively from 0.2 to 1.0 mass % relative to the component (C).

The surface treatment method using component (G) is not particularly limited, but a direct treatment method for the thermally conductive filler, i.e., component (C), an integral blend method, a dry concentrate method, and the like may be used. The direct treatment method includes a dry method, a slurry method, a spray method, and the like. The integral blend method includes a direct method, a master batch method, and the like. From amongst these, the dry method, the slurry method, and the direct method are often used. The total amount of component (G) and the component (C) may be mixed beforehand using a known mixing device, and the surface thereof may be treated. The aforementioned mixing device is not particularly limited, and examples thereof include a single-shaft or twin-shaft continuous mixer, twin roller, Ross mixer, Hobart mixer, dental mixer, planetary mixer, kneader mixer, Henschel mixer and the like.

In specific embodiments, component (C) is blended and surface treated with both components (D) and (G) before combining component (C) in its surface treated form with the other components of the composition. Component (C) may be blended incrementally with components (D) and (G), optionally in the presence of a portion of component (A).

In certain embodiments, the composition further comprises an adhesion promoter. Suitable adhesion promoters may comprise a hydrocarbonoxysilane such as an alkoxysilane, a combination of an alkoxysilane and a hydroxy-functional polyorganosiloxane, an amino functional silane, an epoxy functional silane, a mercapto functional silane, or a combination thereof. Adhesion promoters are known in the art and may comprise silanes having the formula R⁵ₐR⁶_{b}Si(OR⁷)_{4-(a+b)} where each R⁵ is independently a monovalent organic group having at least 3 carbon atoms; R⁶ contains at least one SiC bonded substituent having an adhesion-promoting group, such as amino, epoxy, mercapto or acrylate groups; each R⁷ is independently a monovalent organic group (e.g., methyl, ethyl, propyl, butyl, etc.); subscript a has a value ranging from 0 to 2; subscript b is either 1 or 2; and the sum of (a+b) is not greater than 3. In certain embodiments, the adhesion promoter comprises a partial condensate of the above silane. In these or other embodiments, the adhesion promoter comprises a combination of an alkoxysilane and a hydroxy-functional polyorganosiloxane.

In some embodiments, the adhesion promoter comprises an unsaturated or epoxy-functional compound. In such embodiments, the adhesion promoter may be or comprise an unsaturated or epoxy-functional alkoxysilane such as those having the formula (XIII): R⁸_{c}Si(OR⁹)_{(4-c)}, where subscript c is 1, 2, or 3, alternatively subscript c is 1. Each R⁸ is independently a monovalent organic group with the proviso that at least one R⁸ is an unsaturated organic group or an epoxy-functional organic group. Epoxy-functional organic groups for R⁸ are exemplified by 3-glycidoxypropyl and (epoxycyclohexyl)ethyl. Unsaturated organic groups for R⁸ are exemplified by 3-methacryloyloxypropyl, 3-acryloyloxypropyl, and unsaturated monovalent hydrocarbon groups such as vinyl, allyl, hexenyl, undecylenyl. Each R⁹ is independently a saturated hydrocarbon group of 1 to 4 carbon atoms, alternatively 1 to 2 carbon atoms. R⁹ is exemplified by methyl, ethyl, propyl, and butyl.

Specific examples of suitable epoxy-functional alkoxysilanes include 3-glycidoxypropyltrimethoxysilane, 3-glycidoxypropyltriethoxysilane, (epoxycyclohexyl)ethyldimethoxysilane, (epoxycyclohexyl)ethyldiethoxysilane and combinations thereof. Examples of suitable unsaturated alkoxysilanes include vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof.

In some embodiments, the adhesion promoter comprises an epoxy-functional siloxane, such as a reaction product of a hydroxy-terminated polyorganosiloxane with an epoxy-functional alkoxysilane (e.g., such as one of those described above), or a physical blend of the hydroxy-terminated polyorganosiloxane with the epoxy-functional alkoxysilane. The adhesion promoter may comprise a combination of an epoxy-functional alkoxysilane and an epoxy-functional siloxane. For example, the adhesion promoter is exemplified by a mixture of 3-glycidoxypropyltrimethoxysilane and a reaction product of hydroxy-terminated methylvinylsiloxane with 3-glycidoxypropyltrimethoxysilane, or a mixture of 3-glycidoxypropyltrimethoxysilane and a hydroxy-terminated methylvinylsiloxane, or a mixture of 3-glycidoxypropyltrimethoxysilane and a hydroxy-terminated methylvinyl/dimethylsiloxane copolymer.

In certain embodiments, the adhesion promoter comprises an aminofunctional silane, optionally exemplified by H₂N(CH₂)₂Si(OCH₃)₃, H₂N(CH₂)₂Si(OCH₂CH₃)₃, CH₃NH(CH₂)₃Si(OCH₃)₃, H₂N(CH₂)₃Si(OCH₃)₃, H₂N(CH₂)₃Si(OCH₂CH₃)₃, CH₃NH(CH₂)₃Si(OCH₂CH₃)₃, CH₃NH(CH₂)₅Si(OCH₃)₃, CH₃NH(CH₂)₅Si(OCH₂CH₃)₃, H₂N(CH₂)₂NH(CH₂)₃Si(OCH₃)₃, H₂N(CH₂)₂NH(CH₂)₃Si(OCH₂CH₃)₃, CH₃NH(CH₂)₂NH(CH₂)₃Si(OCH₃)₃, CH₃NH(CH₂)₂NH(CH₂)₃Si(OCH₂CH₃)₃, C₄H₉NH(CH₂)₂NH(CH₂)₃Si(OCH₃)₃, C₄H₉NH(CH₂)₂NH(CH₂)₃Si(OCH₂CH₃)₃, H₂N(CH₂)₂SiCH₃(OCH₃)₂, H₂N(CH₂)₂SiCH₃(OCH₂CH₃)₂, H₂N(CH₂)₃SiCH₃(OCH₃)₂, H₂N(CH₂)₃SiCH₃(OCH₂CH₃)₂, CH₃NH(CH₂)₃SiCH₃(OCH₃)₂, CH₃NH(CH₂)₅SiCH₃(OCH₃)₂, CH₃NH(CH₂)₃SiCH₃(OCH₂CH₃)₂, H₂N(CH₂)₂NH(CH₂)₃SiCH₃(OCH₃)₂, CH₃NH(CH₂)₅SiCH₃(OCH₂CH₃)₂, H₂N(CH₂)₂NH(CH₂)₃SiCH₃(OCH₂CH₃)₂, CH₃NH(CH₂)₂NH(CH₂)₃SiCH₃(OCH₃)₂, CH₃NH(CH₂)₂NH(CH₂)₃SiCH₃(OCH₂CH₃)₂, C₄H₉NH(CH₂)₂NH(CH₂)₃SiCH₃(OCH₃)₂, C₄H₉NH(CH₂)₂NH(CH₂)₃SiCH₃(OCH₂CH₃)₂, N-(3-(trimethoxysilyl) propyl)ethylenediamine, and the like, as well as combinations thereof. In these or other embodiments, the adhesion promoter comprises a mercaptofunctional alkoxysilane, such as 3-mercaptopropyltrimethoxysilane or 3-mercaptopropyltriethoxysilane.

Additional examples of adhesion promoters include the reaction product of an epoxyalkylalkoxysilane, such as 3-glycidoxypropyltrimethoxysilane, and an amino-substituted alkoxysilane, such as 3-aminopropyltrimethoxysilane, optionally with an alkylalkoxysilane, such as methyltrimethoxysilane.

An exemplary adhesion promoter comprises a reaction mixture of an organoalkoxysilane containing an amino group and an organoalkoxysilane containing an epoxy group. Such a reaction mixture is disclosed in Japanese Patent Application Publication S52-8854 B and Japanese Unexamined Patent Application Publication H10-195085 A, which are incorporated by reference herein.

The ratio of the alkoxysilane having an amino group containing organic group to the alkoxysilane having an epoxy group containing organic group is, in terms of the molar ratio, is typically within the range of (1:1.5) to (1:5), alternatively within the range of (1:2) to (1:4). This component can be easily synthesized by mixing alkoxysilane having an amino group containing organic group and alkoxysilane having an epoxy group containing organic group as mentioned above to cause them to react at room temperature or by heating.

In particular, when an alkoxysilane having an amino group containing organic group is reacted with an alkoxysilane having an epoxy group containing organic group by the method described in Japanese Unexamined Patent Application H10-195085A, the present invention may contain a carbasilatrane derivative obtained by cyclizing by an alcohol exchange reaction and expressed by the general formula:

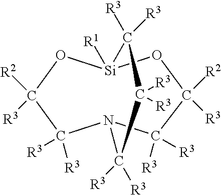

where R¹ is an alkyl group, alkenyl group, or an alkoxy group, and R² is the same or different group selected from the group consisting of groups expressed by the general formula:

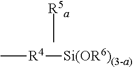

where R⁴ is an alkylene group or alkyleneoxyalkylene group, R⁵ is a monovalent hydrocarbon group, R⁶ is an alkyl group, and a is 0, 1, or 2), or

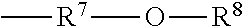

where R⁷ is an alkylene group, R⁸ is an alkyl group, alkenyl group, or acyl group, and R³ is the same or different hydrogen atom or alkyl group. Examples of carbasilatrane derivatives may include carbasilatrane derivatives having a silicon-bonded alkoxy group or a silicon-bonded alkenyl group per molecule represented by the following structure.

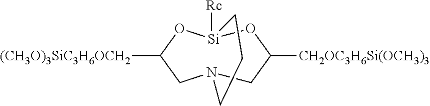

where Rc is a group selected from methoxy groups, ethoxy groups, vinyl groups, allyl groups and hexenyl groups.

Furthermore, in the present invention, a silatran derivative as represented by the following structural formula may be utilized as an adhesion-imparting agent:

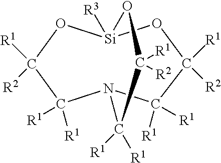

wherein R¹ in the formula is the same or a different hydrogen atom or alkyl group, and R¹ is typically a hydrogen atom or a methyl group. Furthermore, R² in the aforementioned formula is the same or different group selected from a collection consisting of a hydrogen atom, alkyl groups, and organic group containing an alkoxysilyl group as expressed by the general formula:

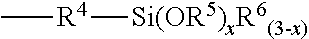

where at least one of the R² is the organic group containing an alkoxysilyl group. Examples of the alkyl group of R² include methyl groups and the like. Furthermore, in the organic group containing an alkoxysilyl group of R², R⁴ in the formula is a divalent organic group, and examples include alkylene groups or alkyleneoxyalkylene groups. An ethylene group, a propylene group, a butylene group, a methyleneoxypropylene group, and a methyleneoxypentylene group are typical. Furthermore, R⁵ in the formula is an alkyl group having 1 to 10 carbon atoms, and is generally a methyl group or an ethyl group. Furthermore, R⁶ in the formula is a substituted or unsubstituted monovalent hydrocarbon group, and typically a methyl group. Furthermore, x in the formula is 1, 2, or 3, and typically 3.

Examples of such an organic group containing an alkoxysilyl group of R² include the following groups.

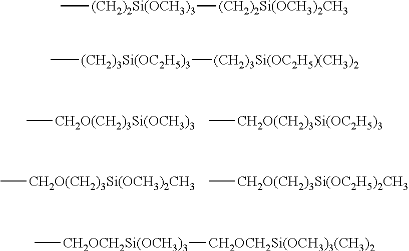

When utilized, the adhesion promoter is present in the composition in an amount of from greater than 0 to 3, alternatively from 0.001 to 2.0, weight percent based on the total weight of the composition.

The curable silicone composition of the present invention may further contain a filler and/or a pigment. When utilized, the filler is different from the thermally conductive filler (C). The filler is not limited and may be, for example, a reinforcing filler, an extending filler, an electrically conductive filler, a flame retarding filler, an acid accepting filler, a rheologically modifying filler, a phosphor, a coloring filler, a mineral filler, a glass filler, a carbon filler, or a combination thereof. The selection of the filler is typically a function of the cured product to be formed with the composition and the end use applications of the cured product.

The filler may be untreated, pretreated, or added in conjunction with an optional filler treating agent, described below, which when so added may treat the filler in situ or prior to incorporation of the filler in the composition. The filler may be a single filler or a combination of two or more fillers that differ in at least one property such as type of filler, method of preparation, treatment or surface chemistry, filler composition, filler shape, filler surface area, average particle size, and/or particle size distribution.

The shape and dimensions of the filler and/or the pigment is also not specifically restricted. For example, the filler may be spherical, rectangular, ovoid, irregular, and may be in the form of, for example, a powder, a flour, a fiber, a flake, a chip, a shaving, a strand, a scrim, a wafer, a wool, a straw, a particle, and combinations thereof. Dimensions and shape are typically selected based on the type of the filler utilized, the selection of other components included within the composition, and the end use application of the cured product formed therewith.

Non-limiting examples of fillers that may function as reinforcing fillers include reinforcing silica fillers such as fume silica, silica aerogel, silica xerogel, and precipitated silica. Fumed silicas are known in the art and commercially available, e.g., fumed silica sold under the name CAB-O-SIL by Cabot Corporation of Massachusetts, U.S.A.

Non-limiting examples fillers that may function as extending or reinforcing fillers include quartz and/or crushed quartz, aluminum oxide, magnesium oxide, silica (e.g., fumed, ground, precipitated), hydrated magnesium silicate, magnesium carbonate, dolomite, silicone resin, wollastonite, soapstone, kaolinite, kaolin, mica muscovite, phlogopite, halloysite (hydrated alumina silicate), aluminum silicate, sodium aluminosilicate, glass (fiber, beads or particles, including recycled glass, e.g., from wind turbines or other sources), clay, magnetite, hematite, calcium carbonate such as precipitated, fumed, and/or ground calcium carbonate, calcium sulfate, barium sulfate, calcium metasilicate, zinc oxide, talc, diatomaceous earth, iron oxide, clays, mica, chalk, titanium dioxide (titania), zirconia, sand, carbon black, graphite, anthracite, coal, lignite, charcoal, activated carbon, non-functional silicone resin, alumina, silver, metal powders, magnesium oxide, magnesium hydroxide, magnesium oxysulphate fiber, aluminum trihydrate, aluminum oxyhydrate, coated fillers, carbon fibers (including recycled carbon fibers, e.g., from the aircraft and/or automotive industries), poly-aramids such as chopped KEVLAR™ or TWARON™, nylon fibers, mineral fillers or pigments (e.g., titanium dioxide, non-hydrated, partially hydrated, or hydrated fluorides, chlorides, bromides, iodides, chromates, carbonates, hydroxides, phosphates, hydrogen phosphates, nitrates, oxides, and sulfates of sodium, potassium, magnesium, calcium, and barium; zinc oxide, antimony pentoxide, antimony trioxide, beryllium oxide, chromium oxide, lithopone, boric acid or a borate salt such as zinc borate, barium metaborate or aluminum borate, mixed metal oxides such as vermiculite, bentonite, pumice, perlite, fly ash, clay, and silica gel; rice hull ash, ceramic and, zeolites, metals such as aluminum flakes or powder, bronze powder, copper, gold, molybdenum, nickel, silver powder or flakes, stainless steel powder, tungsten, barium titanate, silica-carbon black composite, functionalized carbon nanotubes, cement, slate flour, pyrophyllite, sepiolite, zinc stannate, zinc sulphide), and combinations thereof. Alternatively, the extending or reinforcing filler may be selected from the group consisting of calcium carbonate, talc and a combination thereof.

As known in the art, certain fillers may serve as pigments. By way of example, white pigment can comprise include metal oxides such as titanium oxide, aluminum oxide, zinc oxide, zirconium oxide, magnesium oxide, and the like; hollow fillers such as glass balloons, glass beads, and the like; and additionally, barium sulfate, zinc sulfate, barium titanate, aluminum nitride, boron nitride, and antimony oxide. Such components can be considered fillers and/or pigments.

Extending fillers are known in the art and commercially available, such as a ground silica sold under the name MIN-U-SIL by U.S. Silica of Berkeley Springs, WV. Suitable precipitated calcium carbonates include WINNOFIL™ SPM from Solvay and ULTRA-PFLEX™ and ULTRA-PFLEX™ 100 from SMI.

Alternatively or in addition, the filler may comprise a non-reactive silicone resin. For example, the filler may comprise a T resin, a TD resin, a TDM resin, a TDMQ resin, or any other non-reactive silicone resin. Typically, such non-reactive silicone resins include at least 30 mole percent T siloxy and/or Q siloxy units. As known in the art, D siloxy units are represented by R⁰₂SiO_{2/2}, and T siloxy units are represented by R⁰SiO_{3/2}, where R⁰ is an independently selected substituent.

The weight average molecular weight, M_{W}, of the non-reactive silicone resin will depend at least in part on the molecular weight of the silicone resin and the type(s) of substituents (e.g., hydrocarbyl groups) that are present in the non-reactive silicone resin. M_{W} as used herein represents the weight average molecular weight measured using conventional gel permeation chromatography (GPC), with narrow molecular weight distribution polystyrene (PS) standard calibration, when the peak representing the neopentamer is excluded from the measurement. The PS equivalent M_{W} of the non-reactive silicone resin may be from 12,000 to 30,000 g/mole, typically from 17,000 to 22,000 g/mole. The non-reactive silicone resin can be prepared by any suitable method. Silicone resins of this type have been prepared by cohydrolysis of the corresponding silanes or by silica hydrosol capping methods generally known in the art.

Phosphor is a type of filler that can convert the emission wavelength from a light source (optical semiconductor device) when the cured product of the composition is used as a wavelength conversion material. There is no particular limitation on this phosphor, and examples of the phosphor include yellow, red, green, and blue light phosphors, which include oxide phosphors, oxynitride phosphors, nitride phosphors, sulfide phosphors, oxysulfide phosphors, and the like, which are widely used in light emitting diodes (LED).

In certain embodiments, the filler may comprise an acid acceptor. The acid acceptor may comprise a metal oxide such as magnesium oxide. Acid acceptors are generally known in the art and are commercially available under trade names including Rhenofit F, Star Mag CX-50, Star Mag CX-150, BLP-3, and MaxOx98LR. Rhenofit F was calcium oxide from Rhein Chemie Corporation of Chardon, Ohio, USA. Star Mag CX-50 was magnesium oxide from Merrand International Corp. of Portsmouth, N.H., USA. MagOX 98LR was magnesium oxide from Premier Chemicals LLC of W. Conshohocken, Pa., USA. BLP-3 was calcium carbonate was Omya Americas of Cincinnati, Ohio, USA.

Regardless of the selection of the filler, the filler may be untreated, pretreated, or added to form the composition in conjunction with an optional filler treating agent, which when so added may treat the filler in situ in the composition.

The filler treating agent may comprise a silane such as an alkoxysilane, an alkoxy-functional oligosiloxane, a cyclic polyorganosiloxane, a hydroxyl-functional oligosiloxane such as a dimethyl siloxane or methyl phenyl siloxane, an organosilicon compound, a stearate, or a fatty acid. The filler treating agent may comprise a single filler treating agent, or a combination of two or more filler treating agents selected from similar or different types of molecules.

The filler treating agent may comprise an alkoxysilane, which may be a mono-alkoxysilane, a di-alkoxysilane, a tri-alkoxysilane, or a tetra-alkoxysilane. Alkoxysilane filler treating agents are exemplified by hexyltrimethoxysilane, octyltriethoxysilane, decyltrimethoxysilane, dodecyltrimethoxysilane, tetradecyltrimethoxysilane, phenyltrimethoxysilane, phenylethyltrimethoxysilane, octadecyltrimethoxysilane, octadecyltriethoxysilane, and a combination thereof. In certain aspects the alkoxysilane(s) may be used in combination with silazanes, which catalyze the less reactive alkoxysilane reaction with surface hydroxyls. Such reactions are typically performed above 100° C. with high shear with the removal of volatile by-products such as ammonia, methanol and water.

Suitable filler treating agents also include alkoxysilyl functional alkylmethyl polysiloxanes, or similar materials where the hydrolyzable group may comprise, for example, silazane, acyloxy or oximo.

Alkoxy-functional oligosiloxanes can also be used as filler treating agents. Alkoxy-functional oligosiloxanes and methods for their preparation are generally known in the art. Other filler treating agents include mono-endcapped alkoxy functional polydiorganosiloxanes, i.e., polyorganosiloxanes having alkoxy functionality at one end.

Alternatively, the filler treating agent can be any of the organosilicon compounds typically used to treat silica fillers. Examples of organosilicon compounds include organochlorosilanes such as methyltrichlorosilane, dimethyldichlorosilane, and trimethyl monochlorosilane; organosiloxanes such as hydroxy-endblocked dimethylsiloxane oligomer, silicon hydride functional siloxanes, hexamethyldisiloxane, and tetramethyldivinyldisiloxane; organosilazanes such as hexamethyldisilazane and hexamethylcyclotrisilazane; and organoalkoxysilanes such as alkylalkoxysilanes with methyl, propyl, n-cutyl, i-cutyl, n-hexyl, n-octyl, i-octyl, n-decyl, dodecyl, tetradecyl, hexadecyl, or octadecyl substituents. Organoreactive alkoxysilanes can include amino, methacryloxy, vinyl, glycidoxy, epoxycyclohexyl, isocyanurato, isocyanato, mercapto, sulfido, vinyl-benzyl-amino, benzyl-amino, or phenyl-amino substituents. Alternatively, the filler treating agent may comprise an organopolysiloxane. The use of such a filler treating agent to treat the surface of the filler may take advantage of multiple hydrogen bonds, either clustered or dispersed or both, as the method to bond the organosiloxane to the surface of the filler. The organosiloxane capable of hydrogen bonding has an average, per molecule, of at least one silicon-bonded group capable of hydrogen bonding. The group may be selected from: a monovalent organic group having multiple hydroxyl functionalities or a monovalent organic group having at least one amino functional group. Hydrogen bonding may be a primary mode of bonding of the organosiloxane to the filler. The organosiloxane may be incapable of forming covalent bonds with the filler. The organosiloxane capable of hydrogen bonding may be selected from the group consisting of a saccharide-siloxane polymer, an amino-functional organosiloxane, and a combination thereof. Alternatively, the polyorganosiloxane capable of hydrogen bonding may be a saccharide-siloxane polymer.

Alternatively, the filler treating agent may comprise alkylthiols such as octadecyl mercaptan and others, and fatty acids such as oleic acid, stearic acid, titanates, titanate coupling agents, zirconate coupling agents, and a combination thereof. One skilled in the art could optimize a filler treating agent to aid dispersion of the filler without undue experimentation.

If utilized, the relative amount of the filler treatment agent and the filler is selected based on the particular filler utilized as well as the filler treatment agent, and desired effect or properties thereof.

In certain embodiments, the composition further comprises an inhibitor. The inhibitor may be used for altering the reaction rate or curing rate of the composition, as compared to a composition containing the same starting materials but with the inhibitor omitted. The inhibitor is exemplified by acetylenic alcohols such as methyl butynol, ethynyl cyclohexanol, dimethyl hexynol, and 3,5-dimethyl-1-hexyn-3-ol, 1-butyn-3-ol, 1-propyn-3-ol, 2-methyl-3-butyn-2-ol, 3-methyl-1-butyn-3-ol, 3-methyl-1-pentyn-3-ol, 3-phenyl-1-butyn-3-ol, 4-ethyl-1-octyn-3-ol, and 1-ethynyl-1-cyclohexanol, and a combination thereof; cycloalkenylsiloxanes such as methylvinylcyclosiloxanes exemplified by 1,3,5,7-tetramethyl-1,3,5,7-tetravinylcyclotetrasiloxane, 1,3,5,7-tetramethyl-1,3,5,7tetrahexenylcyclotetrasiloxane, and a combination thereof; ene-yne compounds such as 3-methyl-3-penten-1-yne, 3,5-dimethyl-3-hexen-1-yne; triazoles such as benzotriazole; phosphines; mercaptans; hydrazines; amines, such as tetramethyl ethylenediamine, dialkyl fumarates, dialkenyl fumarates, dialkoxyalkyl fumarates, maleates such as diallyl maleate; nitriles; ethers; carbon monoxide; alkenes such as cyclo-octadiene, divinyltetramethyldisiloxane; alcohols such as benzyl alcohol; and a combination thereof. Alternatively, the inhibitor may be selected from the group consisting of acetylenic alcohols (e.g., 1-ethynyl-1-cyclohexanol) and maleates (e.g., diallyl maleate, bis maleate, or n-propyl maleate) and a combination of two or more thereof.

Alternatively, the inhibitor may be a silylated acetylenic compound. Without wishing to be bound by theory, it is thought that adding a silylated acetylenic compound reduces yellowing of the reaction product prepared from hydrosilylation reaction of the composition as compared to a reaction product from hydrosilylation of a composition that does not contain a silylated acetylenic compound or that contains an organic acetylenic alcohol inhibitor, such as those described above.

The silylated acetylenic compound is exemplified by (3-methyl-1-butyn-3-oxy)trimethylsilane, ((1,1-dimethyl-2-propynyl)oxy)trimethylsilane, bis(3-methyl-1-butyn-3-oxy)dimethylsilane, bis(3-methyl-1-butyn-3-oxy)silanemethylvinylsilane, bis((1,1-dimethyl-2-propynyl)oxy)dimethylsilane, methyl(tris(1,1-dimethyl-2-propynyloxy))silane, methyl(tris(3-methyl-1-butyn-3-oxy))silane, (3-methyl-1-butyn-3-oxy)dimethylphenylsilane, (3-methyl-1-butyn-3-oxy)dimethylhexenylsilane, (3-methyl-1-butyn-3-oxy)triethylsilane, bis(3-methyl-1-butyn-3-oxy)methyltrifluoropropylsilane, (3,5-dimethyl-1-hexyn-3-oxy)trimethylsilane, (3-phenyl-1-butyn-3-oxy)diphenylmethylsilane, (3-phenyl-1-butyn-3-oxy)dimethylphenylsilane, (3-phenyl-1-butyn-3-oxy)dimethylvinylsilane, (3-phenyl-1-butyn-3-oxy)dimethylhexenylsilane, (cyclohexyl-1-ethyn-1-oxy)dimethylhexenylsilane, (cyclohexyl-1-ethyn-1-oxy)dimethylvinylsilane, (cyclohexyl-1-ethyn-1-oxy)diphenylmethylsilane, (cyclohexyl-1-ethyn-1-oxy)trimethylsilane, and combinations thereof. Alternatively, the inhibitor is exemplified by methyl(tris(1,1-dimethyl-2-propynyloxy))silane, ((1,1-dimethyl-2-propynyl)oxy)trimethylsilane, or a combination thereof. The silylated acetylenic compound useful as the inhibitor may be prepared by methods known in the art, such as silylating an acetylenic alcohol described above by reacting it with a chlorosilane in the presence of an acid receptor.

The amount of the inhibitor present in the composition will depend on various factors including the desired pot life of the composition, whether the composition will be a one-part composition or a multiple part composition, the particular inhibitor used, and the selection and amount of components (A)-(G). However, when present, the amount of the inhibitor may be 0% to 1%, alternatively 0% to 5%, alternatively 0.001% to 1%, alternatively 0.01% to 0.5%, and alternatively 0.0025% to 0.025%, based on the total weight of the composition.

In some embodiments, the composition further comprises a heat resistance improving agent other than component (G). The other resistance improving agent is exemplified by iron oxide (red iron oxide), cerium oxide, cerium dimethyl silanolate, fatty acid cerium salt, cerium hydroxide, zirconium compound, copper (Cu) phthalocyanine or a combination thereof.

Other than the above components, optional components may be blended in the thermally conductive silicone composition of the present invention within a range such that the object of the present invention is not impaired. Examples of the optional components include inorganic fillers (also referred to as “inorganic filling materials”) such as fumed silica, wet silica, crushed quartz, titanium oxide, magnesium carbonate, zinc oxide, iron oxide, diatomaceous earth, and carbon black; inorganic fillers obtained by hydrophobic treatment of the surface of such inorganic fillers by organosilicon compounds; organopolysiloxanes not containing silicon-bonded hydrogen atoms or silicon-bonded alkenyl groups, heat resistance-imparting agents, cold resistance-imparting agents, thermally conductive fillers, flame retarders, thixotropy-imparting agents, pigments, dyes, and the like. In addition, the thermally conductive silicone gel composition of the present invention may include, if desired, at least one type of antistatic agent comprising a known adhesion-imparting agent, a cationic surfactant, an anionic surfactant, or a nonionic surfactant; dielectric filler; electrically conductive filler; release component; thixotropy-imparting agents; antifungal agent; and the like. If desired, an organic solvent may also be added.

However, in certain embodiments, the composition is substantially free, alternatively free, from organic solvents. By “substantially free,” With reference to the composition being substantially free from organic solvents, means that the composition comprises organic solvents in an amount of less than 10, alternatively less than 5, alternatively less than 4, alternatively less than 3, alternatively less than 2, alternatively less than 1, alternatively 0, wt. % based on the total weight of the composition.

Examples of organic solvents that are generally absent from the composition include an organic oil including a volatile and/or semi-volatile hydrocarbon, ester, and/or ether. General examples of such organic fluids include volatile hydrocarbon oils, such as C₆-C₁₆ alkanes, C₈-C₁₆ isoalkanes (e.g., isodecane, isododecane, isohexadecane, etc.), C₈-C₁₆ branched esters (e.g., isohexyl neopentanoate, isodecyl neopentanoate, etc.), and the like, as well as derivatives, modifications, and combinations thereof. Additional examples of suitable organic fluids include aromatic hydrocarbons (such as benzene, toluene, and xylene), aliphatic hydrocarbons (such as heptane, hexane, and octane), alcohols having more than 3 carbon atoms, aldehydes, ketones (such as acetone, methylethyl ketone, and methyl isobutyl ketone), amines, esters, ethers, glycols, glycol ethers, alkyl halides, aromatic halides, and combinations thereof. Hydrocarbons include isododecane, isohexadecane, Isopar L (C₁₁-C₁₃), Isopar H (C₁₁-C₁₂), hydrogenated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, octyl ether, octyl palmitate, and combinations thereof.

The composition can be cured to give a cured product in the form of a silicone gel having excellent physical properties, including resistance to cracking upon exposure to elevated temperatures for extended periods of time. Because the occurrence of bubbles and cracks can be suppressed, the silicone gel has excellent bonding properties to electrical or electronic parts.

The composition of the present invention can be prepared by mixing each of the above components. For example, it can be prepared by mixing the components (C) and (D) in advance, optionally with component (E), if present, then treating the surface of the component (C) with component (D) and component (E), if present, and then mixing the remaining components and other optional components. Alternatively, the composition can be prepared by mixing components (C) and (D) (and optionally (E)) with component (A), then treating the surface of the component (C) with component (C) and (E) (if utilized), and then mixing the remaining components and other optional components. Similarly, components (B1) and (B2) are typically combined to give component (B) before combining component (B) with the other components. The method for mixing each component may be a conventionally known method, and is not particularly limited. However, mixing the component using a mixing device is usually preferred because a uniform mixture can be obtained by simple stirring. Such a mixing device is not particularly limited, and examples thereof include a single-shaft or twin-shaft continuous mixer, twin roller, Ross mixer, Hobart mixer, dental mixer, planetary mixer, kneader mixer, Henschel mixer and the like.

The composition of the present invention may be used as a one-component type composition (including one-pack type) or, if necessary, as a multi-component type composition (including multi-pack type, especially two-pack type) in which the separated multi-components are mixed at the time of use. In the case of the one-component type, each component of the composition may be used by putting in a single storage container. In the case of the multi-component type, a plurality of separately stored compositions may be mixed and used in a predetermined ratio. Note that, these packages are not particularly limited and may be selected as desired according to a curing method, a coating method, and an application item to be described later.

The composition of the present invention has excellent fluidity, can be applied precisely, and has excellent gap filling ability. Specifically, the viscosity of the composition before curing is in the range of from 10 to 500 Pas at 25° C., and more typically from 50 to 400 Pas at 25° C.

The composition of the present invention is cured by a hydrosilylation reaction to form a silicone cured product having excellent thermal conductivity and adhesion. The temperature for curing this hydrosilylation reaction-curable silicone gel composition is not particularly limited. Surprisingly, the composition is capable of curing at room temperature, which is particularly advantageous for many end use applications. If desired, elevated temperatures in the range of from 20° C. to 150° C., alternatively in the range of from 20 to 80° C., may be utilized to accelerate cure.

The silicone cured product of the present invention preferably has a hardness that satisfies the range of from 10 to 70 and more preferably satisfies the range of from 15 to 60; the hardness is measured in accordance with JIS Type A. In addition, the silicone cured product has a hardness that remains less than 80 (measured in accordance with JIS Type A) even after heating the silicone cured product for 72 hours at 200° C.

The composition of the present invention can stably and highly fill with thermally conductive fillers, such that the compositions and the silicone gel cured products of 2.0 W/mk or more, alternatively 3.0 W/mK or more, alternatively 3.0 to 7.0 W/mK may be designed.

The composition of the present invention is useful as a heat transfer material (thermally conductive member) which is interposable at an interface between the thermal interfaces of a heat generating component and a heat dissipation member, such as a heat sink or circuit board, for conductive cooling of the heat generating component, and can form a heat dissipation structure comprising the same. Here, the type, size, and the detailed structure of the heat generating component are not particularly limited, but the thermally conductive silicone gel composition of the present invention has excellent gap filling ability to a member while having high thermal conductivity, has high adhesion and followability even to the heat generating member having fine irregularities and a narrow gap structure, and has the flexibility inherent to gel. Therefore, the thermally conductive silicone gel composition can be suitably applied to a heat dissipation structure of electric/electronic devices including electric/electronic components or cell type secondary batteries.

Electric/electronic devices comprising the member consisting of the above thermally conductive silicone composition are not particularly limited. Examples thereof include secondary batteries such as cell-type lithium-ion electrode secondary batteries and cell-stacked fuel cells; electronic circuit boards such as printed circuit boards; IC chip packaged with an optical semiconductor device such as a diode (LED), an organic electroluminescent element (organic EL), a laser diode, and an LED array; CPU used in electronic devices such as personal computers, digital video discs, mobile phones, and smartphones; LSI chips such as driver ICs and memories; and the like. Particularly, in high performance digital switching circuits formed with high integration density, heat removal (heat dissipation) becomes a key factor in the performance and reliability of integrated circuits. However, the thermally conductive member using the thermally conductive silicone gel composition according to the present invention has excellent heat dissipation and handleability even when it is applied to power semiconductor applications such as engine control, power train system and air conditioner control in air transport; and has excellent heat resistance and thermal conductivity even when used in a harsh environment built into an in-vehicle electronic part such as an electronic control unit (ECU). Further, the thermally conductive silicone gel composition according to the present invention may be disposed not only on a horizontal surface but also on a vertical surface by controlling the rheology thereof, and it may also penetrate into the microstructure of the heat generating components, such as electric/electronic components or secondary batteries, to provide a heat dissipation structure without gaps. Thus, the heat dissipation of electric/electronic devices comprising the heat dissipation structure can be improved; the problem of latent heat and thermal runaway can be improved as well as a flexible gel-like cured product can protect a substructure of electric/electronic devices, thereby improving its reliability and operational stability.

Examples of the material constituting the above electric/electronic devices include resin, ceramic, glass, and metal such as aluminum. The thermally conductive silicone gel composition of the present invention can be applied to the substrates thereof both as a thermally conductive silicone gel composition (fluid) before curing and as a thermally conductive silicone cured product.

For heat generating components, the method of forming a heat dissipation structure using the thermally conductive silicone gel composition of the present invention is not limited, and example includes a method of curing the composition by pouring the thermally conductive silicone gel composition of the present invention into the heat dissipation parts for electric/electronic components, to sufficiently fill the gaps, and then left at room temperature or optionally heated.

In applications where rapid curing is required, a method of heating and curing is particularly preferable since the entire material can be cured relatively quickly. At this time, increase in the heating temperature promotes the generation of bubbles and cracks in the sealing agent for the electric/electronic components that are being sealed or filled. Therefore, the heating is preferably performed within the range of from 50 to 250° C.; particularly preferably within the range of from 70 to 130° C. In the case of thermal curing, the composition may be formed into a one-pack type package. In this case, from the viewpoint of improving the handleability and the pot life of the composition, a platinum-containing hydrosilylation reaction catalyst in which particulates are dispersed or encapsulated in a thermoplastic resin may be used, and is preferable.

The thermally conductive silicone gel composition of the present invention may be cured under heating at room temperature or at 50° C. or lower. In this case, the composition may be formed into a one-pack type or multi-pack type package. And, after mixing, it is preferable to cure the composition under heating at room temperature or 50° C. or lower over 1 hour to several days.

The form, thickness and arrangement of the thermally conductive silicone gel obtained by the above curing can be designed as desired. It may be cured if necessary after filling in the gaps of electric/electronic devices and it may be applied or cured on a film provided with a release layer (separator), and may be handled alone as a thermally conductive silicone gel cured product on the film. Further, in that case, a form of a thermally conductive sheet reinforced by a known reinforcing material may be used.

The thermally conductive silicone gel composition of the present invention has excellent gap filling ability and forms a gel-like thermally conductive member having excellent flexibility and thermal conductivity. Therefore, it is also effective for those having narrow gaps between electrical elements and packages, between electrical elements and between electrodes in electric/electronic components, and those having a structure in which above structures are difficult to follow the expansion and contraction of the silicone gel. For example, it can also be used for semiconductor devices such as secondary batteries, ICs, hybrid ICs, and LSIs; electric circuits and modules in which such a semiconductor devices, capacitor, electric resistor and other electric elements are mounted; various sensors such as pressure sensors; igniters and regulators for automobiles, power generation systems, or power devices such as space transportation systems.

The following examples are intended to illustrate the invention and are not to be viewed in any way as limiting to the scope of the invention.

Certain components utilized in the Examples are set forth in Table 1 below.

The following examples are intended to illustrate the invention and are not to be viewed in any way as limiting to the scope of the invention.

Certain components utilized in the Examples are set forth in Table 1 below.

TABLE 1

| Components/Compounds | |
|---|---|
| Utilized Abbreviation | Meaning/Definition |
| Organopolysiloxane | Linear dimethylvinyl-terminated polydimethylsiloxane polymer |
| (A-1) | having a viscosity at 25° C. of 60 mPa's and a vinyl group content |
| | of 1.44 wt.%. |
| Organopolysiloxane | Linear methylvinyl-terminated polydimethylsiloxane polymer |
| (A-2) | having a viscosity at 25° C. of 380 mPas and a vinyl group |
| | content of 0.44 wt. %. |
| Organosilicon Compound (B-1) | 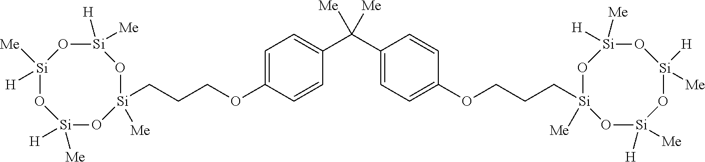 [SMILES: C[SiH]1O[SiH](C)O[Si](C)(CCCOc2ccc(C(C)(C)c3ccc(OCCC[Si]4(C)O[SiH](C)O[SiH](C)O[SiH](C)O4)cc3)cc2)O[SiH](C)O1] |
| Organohydrogen- | An organohydrogenpolysiloxane having the formula M^{H}D₁₄M^{H} |
| polysiloxane (B2-1) | |
| Organohydrogen- | An organohydrogenpolysiloxane having the formula MD₂₂D^{H}₂M |
| polysiloxane (B2-2) | |
| Filler (C-1) | Ground alumina having an average particle diameter of 0.40 μm. |
| Filler (C-2) | Ground alumina having an average particle diameter of 3 |
| | um. |
| Filler (C-3) | Spherical alumina having an average diameter of 5 μm. |
| Filler (C-4) | Spherical alumina having an average diameter of 40 μm. |
| Siloxane | MD₂₉Si(OMe)₃ |
| Macromonomer (D) | |
| Catalyst (E) | Platinum(0)-1,3-divinyl-1,1,3,3-tetramethyldisiloxane |
| | complex in dimethylsilicone polymer |
| Heat Resistance | Phthalocyanine copper 40% masterbatch in dimethyl |
| Imparting Agent (F-1) | silicone polymer |
| Heat Resistance | Carbon black |
| Imparting Agent (F-2) | |
| Alkoxysilane (G) | Decyltrimethoxysilane |
| Inhibitor | CH₃Si(OC(CH₃)₂-CCH)₃ |
| Base Composition 1 | As prepared in Preparation Example 1 |
| Base Composition 2 | As Prepared in Preparation Example 2 |
| D^{H} | (CH₃)HSiO_{2/2} |
| M^{H} | (CH₃)₂HSiO_{1/2} |
| D | (CH₃)₂SiO_{2/2} |
| M | (CH₃)₃SiO_{1/2} |
| Me | Methyl |

### Preparation Example 1 and 2

Base Compositions 1 and 2 were prepared for use in preparing compositions in later examples. Table 2 below shows the amount of each component present in Base Compositions 1 and 2, respectively, as prepared in Preparation Examples 1 and 2. The values in Table 2 are parts by weight, with the sum of each of Base Compositions 1 and 2 being 95 parts by weight. Base Compositions 1 and 2 can alternatively be referred to as masterbatches.

TABLE 2

| Component: | Base Composition 1 | Base Composition 2 |
|---|---|---|
| Organopolysiloxane | 4.50 | 4.50 |
| (A-1) | | |
| Siloxane Macromonomer (D) | 0.70 | 0.90 |
| Alkoxysilane (G) | 0.20 | 0 |
| Filler (C-1) | 18.80 | 18.80 |
| Filler (C-2) | 20.80 | 20.80 |
| Filler (C-3) | 50.00 | 50.00 |

### General Procedure 1: Preparation Examples 1 and 2

Base Compositions 1 and 2 were prepared in accordance with General Procedure 1. In General Procedure 1, Organopolysiloxane (A-1), Siloxane Macromoner (D), and Alkoxysilane (G) (if utilized) were disposed in a 1 L planetary mixer. Then, the Filler (C-1) and Filler (C-2) were disposed in the mixer and mixed at room temperature for 10 minutes. Then, half of the amount of the Filler (C-4) utilized was disposed in the mixer, followed by mixing for another 10 minutes at room temperature. Then, the remaining half of the Filler (C-4) utilized was disposed in the mixer, followed by scraping and further mixing for 10 minutes at room temperature.

### Examples 1-9 and Comparative Examples 1-4

Compositions were prepared in Examples 1-9 and Comparative Examples 1-4. Tables 3 and 4 below shows the amount of each component present in Examples 1-9 and Comparative Examples 1-4. The values in Table 3 and 4 are parts by weight unless otherwise indicated. The SiH/Vi molar ratio reported below for each composition is to the exclusion of the Inhibitor and component (E).

TABLE 3
Examples 1-7

| Component | Ex. 1 | Ex. 2 | Ex. 3 | Ex. 4 | Ex. 5 | Ex. 5 | Ex. 7 |
|---|---|---|---|---|---|---|---|
| Base | 95.00 | 95.00 | 95.00 | 95.00 | 95.00 | 95.00 | 95.00 |
| Composition 1 | | | | | | | |
| (A-1) | 2.14 | 1.34 | 2.49 | 2.13 | 2.39 | 2.30 | 0 |
| (A-2) | 0 | 0 | 0 | 0 | 0 | 0 | 2.55 |
| (B2-1) | 2.50 | 2.50 | 2.06 | 2.46 | 2.20 | 2.32 | 2.10 |
| (B1) | 0.06 | 0.06 | 0.15 | 0.10 | 0.10 | 0.07 | 0.06 |
| (F-1) | 0.20 | 0 | 0.20 | 0.20 | 0.20 | 0.20 | 0.20 |
| Blend of 45% | 0 | 1.00 | 0 | 0 | 0 | 0 | 0 |
| (A-1) in 55% (F-2) | | | | | | | |
| Inhibitor | 0.01 | 0.01 | 0.01 | 0.01 | 0.01 | 0.01 | 0.01 |
| (E) | 0.10 | 0.10 | 0.10 | 0.10 | 0.10 | 0.10 | 0.10 |
| (6000 Ppm Pt) | | | | | | | |
| TOTAL | 100.01 | 100.01 | 100.01 | 100.00 | 100.00 | 100.00 | 100.02 |
| H/Vi | 1.01 | 1.07 | 1.00 | 1.09 | 0.96 | 0.95 | 1.09 |
| SiH of (B1)/ | 0.15 | 0.15 | 0.46 | 0.26 | 0.29 | 0.19 | 0.18 |
| SiH of (B2) | | | | | | | |

TABLE 4
Examples 8-9 and Comparative Examples 1-4

| Component | Ex. 8 | Ex. 9 | C.E. 1 | C.E. 2 | C.E. 3 | C.E. 4 |
|---|---|---|---|---|---|---|
| Base Composition 1 | 95.00 | 0 | 95.00 | 95.00 | 95.00 | 95.00 |
| Base Composition 2 | 0 | 95.00 | 0 | 0 | 0 | 0 |
| (A-1) | 2.41 | 2.39 | 1.80 | 2.88 | 3.24 | 0 |
| (A-2) | 0 | 0 | 0 | 0 | 0 | 1.61 |
| (B2-1) | 0 | 2.20 | 2.80 | 1.51 | 1.20 | 2.00 |
| (B2-2) | 2.20 | 0 | 0 | 0 | 0 | 0 |
| (B1) | 0.08 | 0.10 | 0.10 | 0.30 | 0.25 | 0.080 |
| (F-1) | 0.20 | 0.20 | 0.20 | 0.20 | 0.20 | 0.20 |
| Inhibitor | 0.01 | 0.01 | 0.01 | 0.01 | 0.01 | 0.01 |
| (E) (6000 Ppm Pt) | 0.10 | 0.10 | 0.10 | 0.10 | 0.10 | 0.10 |
| Isoparaffin solvent | 0 | 0 | 0 | 0 | 0 | 1.00 |
| TOTAL | 100.00 | 100.00 | 100.01 | 100.00 | 100.00 | 100.00 |
| H/Vi | 0.76 | 0.96 | 1.27 | 1.08 | 0.84 | 1.17 |
| SiH of (B1)/SiH of (B2) | 0.29 | 0.29 | 0.23 | 1.27 | 1.33 | 0.25 |

### General Procedure 2: Examples 1-9 and Comparative Examples 1-4

5 The Compositions of Examples 1-9 and Comparative Examples 1-4 were prepared in accordance with General Procedure 2. In General Procedure 2, Base Composition 1 or 2 was heated to 160° C. under a vacuum for 60 minutes, and then cooled to room temperature under vacuum over 30 minutes. Then, the remaining components other than the Catalyst (E) were disposed in the planetary mixer, and the contents of the mixer were mixed for 15 minutes at room temperature. The contents were removed from the mixture, mixed with the Catalyst (E), and de-aired for 3 minutes. The compositions were then cured to give thermally conductive members, and physical properties were measured as described below.

### Hardness

Hardness of each thermally conductive member was measured in with a JIS TYPE A hardness tester. In particular, a mold having plate dimensions of 120 mm×120 mm×2 mm was used with a PTFE sheet between each plate of the mold. Each composition was disposed in the mold to form a sheet having a thickness of 2 mm, and cured in a hot press for 60 minutes at 120° C., followed by measuring JIS TYPE A hardness with the JIS TYPE A hardness tester. Hardness was measured by stacking three sheets on top of one another. Hardness was also measured after aging each thermally conductive member for 72 hours at 200° C.

### Thermal Conductivity (Hot Disk)

Thermal conductivity of each thermally conductive member was measured via a hot disk. More specifically, a test piece of the thermally conductive member was prepared in a mold having plate dimensions of 50 mm×30 mm×6 mm with a PTFE sheet between each plate of the mold. Each composition was disposed in the mold to form a sheet having a thickness of 6 mm, and cured in a hot press for 60 minutes at 120° C. The sheet was removed from the mold and stored for 24 hours at 25° C. Then, a Hot Disk TPS 500S from Hot Disk AB of Goteborg, Sweden was used to measure thermal conductivity of two samples, which was averaged and reported below.

### Lap Shear Strength and Cohesive Failure Ratio

Adhesion strength (MPa) and cohesive failure ratio (%) of each thermally conductive member was measured by first cleaning aluminum diecasting substrates (ADC12) with isopropyl alcohol. Each composition was filled into an overlap area defined by the aluminum diecasting substrates having dimensions of 10 mm×24 mm×1 mm. Each composition was cured in a hot press for 60 minutes at 120° C. while disposed in the overlap area defined by the substrates. After curing, excess cured product was removed from the perimeter of the overlap area via a cutter, and properties were measured via a tensile testing with a measuring speed of 50 mm/min.

Tables 5 and 6 below show the physical properties measured for the thermally conductive members formed with the compositions of each of Examples 1-9 and Comparative Examples 1-4.

TABLE 5
Examples 1-7

| Property | Ex. 1 | Ex. 2 | Ex. 3 | Ex. 4 | Ex. 5 | Ex. 5 | Ex. 7 |
|---|---|---|---|---|---|---|---|
| Specific Gravity | 2.96 | 2.98 | 2.98 | 2.97 | 2.97 | 2.97 | 2.97 |
| Hardness | 28 | 50 | 30 | 49 | 27 | 22 | 59 |
| (JIS TYPE A) | | | | | | | |
| Hardness after | 52 | 66 | 73 | 75 | 63 | 48 | 71 |
| aging (JIS TYPE A) | | | | | | | |
| Adhesion strength | 0.47 | 0.71 | 0.49 | 0.67 | 0.44 | 0.43 | 0.91 |
| (MPa) | | | | | | | |
| Cohesive | 100% | 100% | 100% | 100% | 100% | 100% | 100% |
| failure ratio (%) | | | | | | | |

TABLE 6
Examples 8-9 and Comparative Examples 1-4

| Property | Ex. 8 | Ex. 9 | C.E. 1 | C.E. 2 | C.E. 3 | C.E. 4 |
|---|---|---|---|---|---|---|
| SG | 2.97 | 2.97 | 2.97 | 2.97 | 2.98 | 2.95 |
| Hardness | 18 | 34 | 69 | 63 | 23 | 62 |
| (JIS TYPE A) | | | | | | |
| Hardness after aging | 79 | 50 | 85 | 90 | 81 | 89 |
| (JIS TYPE A) | | | | | | |
| Adhesion strength | 0.27 | 0.53 | 1.21 | 0.82 | 0.41 | 0.73 |
| (MPa) | | | | | | |
| Cohesive failure | 100% | 100% | 100% | 100% | 100% | 10% |
| ratio (%) | | | | | | |

1. A thermally conductive silicone composition comprising:
(A) 100 parts by mass of an alkenyl group-containing organopolysiloxane having a viscosity of from 10 to 100,000 mPa·s at 25° C.;
(B) a mixture of components (B1) and (B2):
(B1) an organosilicon compound of 1 to 100 silicon atoms containing at least one phenylene structure and at least one silicon-bonded hydrogen atom per molecule, and
(B2) an organohydrogenpolysiloxane containing an average of 2 to 4 silicon-bonded hydrogen atoms per molecule and having a viscosity of from 1 to 1,000 mPa·s at 25° C., but no phenylene structure in the molecule,
wherein the total amount of silicon-bonded hydrogen atoms in component (B) is from 0.5 to 1.1 mol per 1 mol of alkenyl groups contained in component (A), and the molar ratio of silicon-bonded hydrogen atoms in component (B1) per component (B2) is from 0.1 to 1.0;
(C) 400 to 3,500 parts by mass of a thermally conductive filler;
(D) a siloxane macromonemer represented by following formula (I) or formula (II) 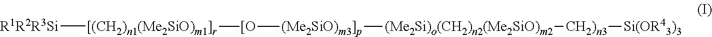
wherein each Me is a methyl group, R¹, R² and R³ are independently selected from an alkyl group having 1 to 20 carbon atoms, an alkenyl group having 2 to 4 carbon atoms, an alkoxy group having 1 to 3 carbon atoms, or —(OSiR⁷R⁸R⁹), wherein R⁷, R⁸ and R⁹ are each independently selected from an alkyl group having 1 to 4 carbon atoms, R⁴ is an alkyl group having 1 to 4 carbon atoms, n1, n2, m1, m3 and o are integers from 1 to 200, m2, n3, r and p are integers from 0 to 200, r and p are not 0 at the same time; 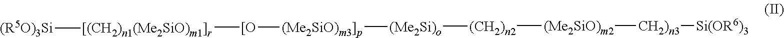
wherein R⁵ and R⁶ are an alkyl group having 1 to 4 carbon atoms, n1, m1, m3, o and n2 are integers from 1 to 200, n3, n4, m2, r and p are integers from 0 to 200, r and p are not 0 at the same time; and
(E) a catalytic amount of a hydrosilylation reaction catalyst.

2. The thermally conductive silicone composition according to claim 1, further comprising:
(F) a heat resistance imparting agent.

3. The thermally conductive silicone composition according to claim 1, further comprising:
(G) an alkoxysilane having an alkyl group with 6 or more carbon atoms.

4. The thermally conductive silicone composition according to claim 3, wherein component (G) is a trialkoxysilane having an alkyl group having 6 to 18 carbon atoms.

5. The thermally conductive silicone composition according to claim 1, wherein the composition is substantively free from organic solvents.

6. The thermally conductive silicone composition according to claim 1, wherein the composition is a room temperature curing-type thermally conductive silicone composition.

7. The thermally conductive silicone composition according to claim 1, wherein the composition is heat-curing-type thermally conductive silicone composition.

8. A thermally conductive member comprising the thermally conductive silicone composition according to claim 1.

9. A thermally conductive member obtained by curing the thermally conductive silicone composition according to claim 1.

10. A heat dissipation structure comprising the thermally conductive member according to claim 8.

11. The heat dissipation structure according to claim 10, which is an electric/electronic device.

12. The heat dissipation structure according to claim 10, which is electric/electronic component or a secondary battery.

13. The thermally conductive silicone composition according to claim 2, further comprising:
(G) an alkoxysilane having an alkyl group with 6 or more carbon atoms.

14. The thermally conductive silicone composition according to claim 13, wherein component (G) is a trialkoxysilane having an alkyl group having 6 to 18 carbon atoms.
